(19) United States
(12) Patent Application Publication
(10) Pub. No.: US 2010/0011370 A1
(43) Pub. Date: Jan. 14, 2010

(54) CONTROL UNIT, DISTRIBUTED PROCESSING SYSTEM, AND METHOD OF DISTRIBUTED PROCESSING

(75) Inventors: Mitsunori Kubo, Tokyo (JP); Arata Shinozaki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/494,743

(22) Filed: Jun. 30, 2009

(30) Foreign Application Priority Data
Jun. 30, 2008 (JP) JP 2008-170760
Jun. 23, 2009 (JP) JP 2009-148353

(51) Int. Cl. G06F 9/50; G06F 9/46

(52) U.S. Cl. 718/104; 718/102

(57) ABSTRACT

A control unit includes a determination section that determines information on a type and a function of processing elements connected thereto, a library loading section that loads, as needed, program information or reconfiguration information for hardware included in a connected library into the processing elements, and execution transition information control section that creates, based on information on an arbitrary service comprising a combination of one or more tasks to be executed by the processing elements and information on the type and the function of the processing elements determined by the determination section, execution transition information specifying a combination of processing elements corresponding to the information on service and transmits it to the processing elements.

### CROSS-REFERENCE TO RELATED APPLICATION

The present application is based upon and claims the benefit of priority from the prior Japanese Patent Application No. 2008-170760 filed on Jun. 30, 2008 and No. 2009-148353 filed on Jun. 23, 2009; the entire contents of which are incorporated herein by reference.

### BACKGROUND OF THE INVENTION

1. Field of the Invention

The present invention relates to a control unit, a distributed processing system and a distributed processing method.

2. Description of the Related Art

Conventionally, automatic downloading of a program(s) as update data from a server(s) to correct, change, and/or extend the function of specific hardware or software has been performed. This is a system of correcting, changing, and/or extending the function of hardware or software by automatically downloading a program as update data from a server.

In operating systems such as Linux and Windows (registered trademark), a program(s) is automatically downloaded, as needed at a later time, from a server(s) and installed (see, for example, Server Kochiku Kenkyukai (Server Construction Study Group) “Fedora Core 5 De Tsukuru Network Server Kochiku Guide (Guide to Network Server Construction with Fedora Core 5)” Shuwa System (2006), pp. 88-101). Examples of downloaded data include update data for improving security, data for updating the function of application software and so on.

As described above, there has been known a system of automatically downloading a program(s) from a server(s) as update data to correct, change, and/or extend the function of hardware or software.

### SUMMARY OF THE INVENTION

According to a first aspect of the present invention, there can be provided a control unit to which processing elements are connected, characterized in that said control unit comprises:

a determination section that determines information on a type and a function of said connected processing elements;

a library loading section that loads, as needed, program information or reconfiguration information for hardware included in a connected library into said processing elements; and

execution transition information control section that creates, based on information on an arbitrary service comprising a combination of one or more tasks to be executed by said processing elements and information on the type and the function of said processing elements determined by said determination section, execution transition information specifying a combination of said processing elements corresponding to said information on service and transmits it to said processing elements.

According to a second aspect of the present invention, there can be provided a distributed processing system including processing elements and a control unit to which said processing elements are connected, characterized in that said control unit comprises:

a determination section that determines information on a type and a function of said connected processing elements;

a library loading section that loads, as needed, program information or reconfiguration information for hardware included in a connected library into said processing elements; and

execution transition information control section that creates, based on information on an arbitrary service comprising a combination of one or more tasks to be executed by said processing elements and information on the type and the function of said processing elements determined by said determination section, execution transition information specifying a combination of said processing elements corresponding to said information on service and transmits it to said processing elements.

According to a third aspect of the present invention, there can be provided a distributed processing method characterized by comprising:

a determination step of determining information on a type and a function of said processing elements connected to a control unit;

a library loading step of loading, as needed, program information or reconfiguration information for hardware included in a connected library into said processing elements;

execution transition information control step of creating, based on information on an arbitrary service comprising a combination of one or more tasks to be executed by said processing elements and information on the type and the function of said processing elements determined by said determination section, execution transition information specifying a combination of said processing elements corresponding to said information on service and transmitting it to said processing elements; and

processing path determination step in which said processing elements or said client determines whether said task pertinent thereto specified in said execution transition information received thereby is executable or not, whereby a processing path of the tasks specified in said execution transition information is determined.

### BRIEF DESCRIPTION OF THE DRAWINGS

FIG. 1A is a diagram showing a model of a distributed processing system including a control unit according to a first embodiment of the present invention.

FIG. 1B is a diagram showing the general configuration of the entire processing system including the control unit according to the first embodiment.

FIG. 2 is a flow chart showing a procedure of JPEG decoding.

FIG. 3 is a diagram showing a relationship between TIDs and tasks.

FIG. 4 is a diagram showing a relationship between a SID and a service.

FIG. 5 is a diagram showing PE types.

FIG. 6 is a diagram showing a listing of libraries.

FIG. 7 is a diagram showing a processing element connection list.

FIG. 8 is a diagram showing a task execution transition table.

FIG. 9 is a diagram showing a service-task correspondence table.

FIG. 10 is a flow chart showing a basic control in a control unit according to the first embodiment.

FIG. 11 is a flow chart showing a basic control in a service execution requesting processing element according to the first embodiment.

FIG. 12 is another flow chart showing a basic control in a processing element according to the first embodiment.

FIG. 13 is a flow chart showing a control in the control unit according to the first embodiment.

FIG. 14 is a flow chart showing a control in the control unit according to the first embodiment.

FIG. 15 is a flow chart showing a control in the processing element according to the first embodiment.

FIG. 16A is a flow chart showing a control in the processing element according to the first embodiment.

FIG. 16B is a diagram showing a correspondence between a flow of JPEG decoding process and the system configuration according to the first embodiment.

FIG. 17 is a diagram showing the system configuration according to the first embodiment.

FIG. 18 is a diagram showing a processing element connection list according to the first embodiment.

FIG. 19 is a diagram showing a service-task correspondence table according to the first embodiment.

FIG. 20 is a diagram showing a part of a sequence according to the first embodiment.

FIG. 21 is a diagram showing a task execution transition table according to the first embodiment.

FIG. 22 is another diagram showing a sequence according to the first embodiment.

FIG. 23 is another diagram showing a sequence according to the first embodiment.

FIG. 24 is another diagram showing a sequence according to the first embodiment.

FIG. 25 is a diagram showing a processing element connection list according to the first embodiment.

FIG. 26 is another diagram showing a sequence according to the first embodiment.

FIG. 27 is a diagram showing a sequence according to the first embodiment.

FIG. 28 is a diagram showing a sequence according to the first embodiment.

FIG. 29 is a diagram showing a sequence according to the first embodiment.

FIG. 30 is a diagram showing a sequence according to the first embodiment.

FIG. 31A is a diagram showing a model of a distributed processing system including a control unit according to a second embodiment of the present invention.

FIG. 31B is a diagram showing a correspondence between a flow of JPEG decoding process and the system configuration according to the second embodiment.

FIG. 32 is a flow chart showing a basic control in a processing element according to the second embodiment.

FIG. 33 is a flow chart showing a control in the processing element according to the second embodiment.

FIG. 34A is a diagram showing a model of a distributed processing system including a control unit according to a third embodiment of the present invention.

FIG. 34B is a diagram showing a correspondence between a flow of JPEG decoding process and the system configuration according to the third embodiment.

FIG. 35 is a flow chart showing a basic control in a processing element according to the third embodiment.

FIG. 36 is a flow chart showing a control in the processing element according to the third embodiment.

### DETAILED DESCRIPTION OF THE INVENTION

In the following, embodiments of the control unit according to the present invention will be described in detail with reference to the accompanying drawings. The present invention is not limited to the embodiments.

### First Embodiment

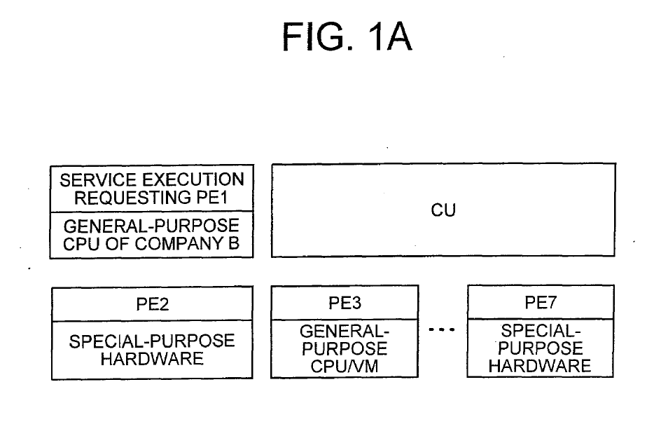

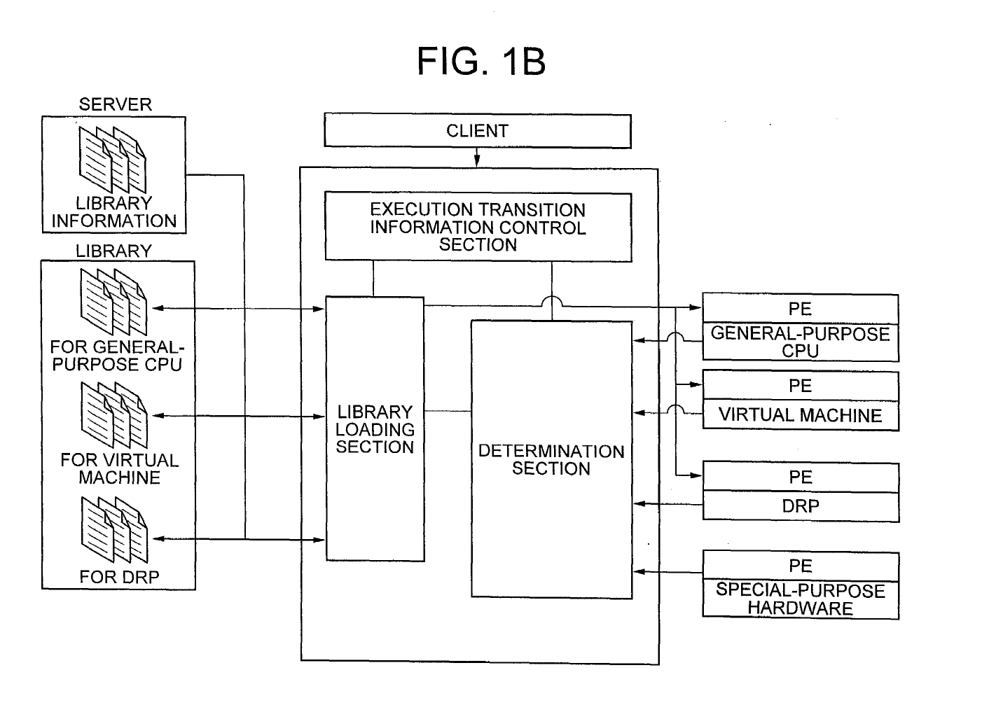

FIG. 1A shows a model of a distributed processing system including a control unit according to an embodiment. Seven processing elements PE1 to PE7 are connected to a control unit CU. The processing element PE1, which is a service execution requesting processing element, is a general-purpose CPU manufactured by Company B. The processing element PE3 is a general-purpose CPU or a virtual machine. The processing elements PE2 and PE4 to PE7 are special-purpose hardware. The processing elements PE2 and PE4 to PE7 may be special-purpose software that provides specific functions.

There is not a difference between the general-purpose CPU and the virtual machine in regard that they load a program suitable for the processing element type at an appropriate time. Therefore, the general-purpose CPU and the virtual machine will be handled in the same manner.

In the following embodiments, a case in which JPEG decoding is executed will be discussed.

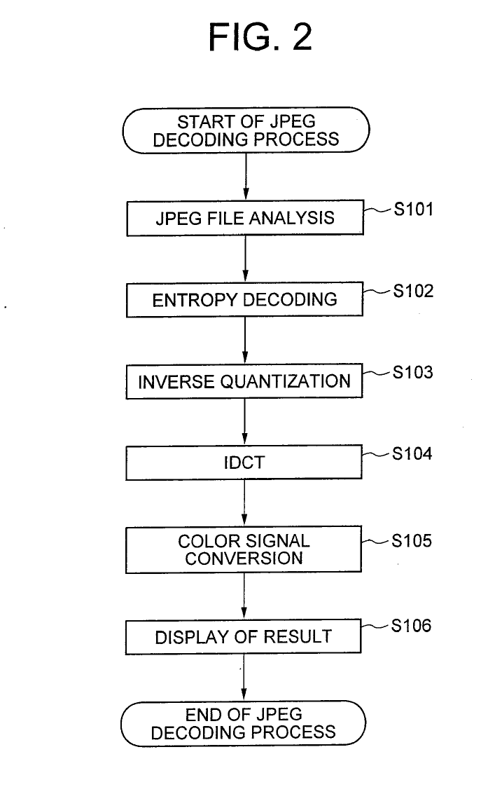

FIG. 2 is a flow chart showing a procedure of JPEG decoding. In step S101 in FIG. 2, analysis of a JPEG file is performed. In step S102, entropy decoding is performed. In step S103, inverse quantization is performed. In step S104, IDCT (Inverse Discrete Cosine Transform) is performed. In step S105, color signal conversion is performed. In the case where the JPEG file has been sampled, step S105 includes upsampling performed before color signal conversion. In step S106, a result is displayed. Then, the JPEG decoding process is terminated.

Here, terms used in the embodiments will be defined in advance. The term “task” refers to a unit of execution of a certain organized function. Every step in the JPEG decoding shown in FIG. 2 is composed of a single task. For example, the inverse quantization is a task.

Each task is provided with an identification number called a task identifier (TID).

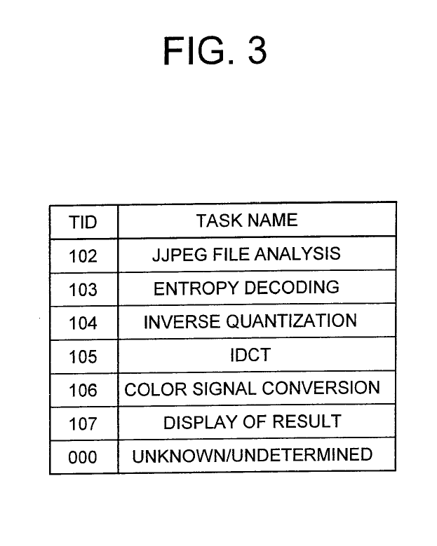

As shown in FIG. 3, functions implemented by tasks and TIDs are in one to one correspondence.

The term “processing element” (which will be herein after referred to as “PE” arbitrarily) refers to a unit component of a system that implements one or more of the following four functions: data input/output, processing, transmission, and storage. In general, one processing element has the function of processing one or more tasks and the function of inputting/outputting data needed in the processing and the function of storing data.

The term “control unit” (which will be herein after referred to as “CU” arbitrarily) refers to a control section that performs assignment of a task(s) to each processing element in the distributed processing system, management of processing paths and management of transition of task execution during the execution of a service.

The term “service” refers to a set of one or more related tasks. The service provides a process having a more organized purpose than the task. JPEG decoding process is an example of the service. Each service is also provided with a unique identification number called a service identifier (SID).

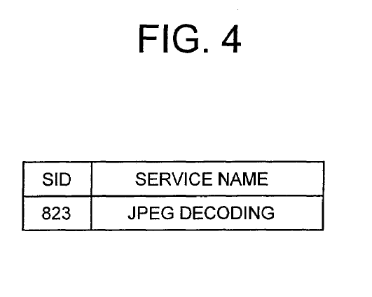

FIG. 4 shows an example of the correspondence between a service and a service identifier. A processing element that requests the execution of a service is particularly referred to as a “service execution requesting processing element (client)”. The client only requests the execution of a service(s) but does not execute a task(s), or requests the execution of a service(s) and executes a task(s).

There are cases where one task constitutes a service. For example, when IDCT process is requested as a service, the result of the IDCT process performed on an input is returned. It is not necessary for the service execution requesting processing element to receive the result data. There are cases where the service terminates in display and/or storage of data in another processing element.

The term “function identifier (FID)” refers to an identifier of a task that is executable by each processing element. Therefore, FIDs associated with functions implemented by tasks and TIDs are in one to one correspondence. One processing element may have two or more FIDs. In this embodiment, special-purpose hardware and a dynamic reconfigurable processor (DRP) have only one FID at a time. Practically, there are cases where they have two or more FIDs. In the case assumed herein, a central processing unit (CPU) and a virtual machine (VM) have a plurality of FIDs.

The term “library” refers to a set of programs (software) for implementing functions the same as those of special-purpose hardware or the like on a CPU or a virtual machine, which is a general-purpose processing element, and reconfiguration information for a dynamic reconfigurable processor (DRP). Programs that are in one to one correspondence with the functions implemented in the special-purpose hardware are prepared. These programs can be stored in a database in the library. The system is configured in such a way that the stored programs and the reconfiguration information can be searched for by means of a look-up table (LUT) or the like.

The term “processing element type (PET)” refers to an identifier representing the type, architecture, and version etc. of a processing element. The processing elements include special-purpose hardware or special-purpose software, dynamic reconfigurable processors, general-purpose CPUs and virtual machines.

The special-purpose hardware and the special-purpose software execute a specific function. In the dynamic reconfigurable processor, hardware can be reconfigured in an optimized manner in real time in order to execute a specific function. The general-purpose CPU can execute general-purpose functions through programs.

The configuration including information on the correspondence between specific functions of special-purpose processing elements including special-purpose hardware and special-purpose software and programs for implementing the specific functions on general-purpose processing elements or reconfiguration information for DRPs, and the above-mentioned programs or the above-mentioned reconfiguration information, in other word, a listing of libraries and the programs or the reconfiguration information, constitutes a dynamic processing library.

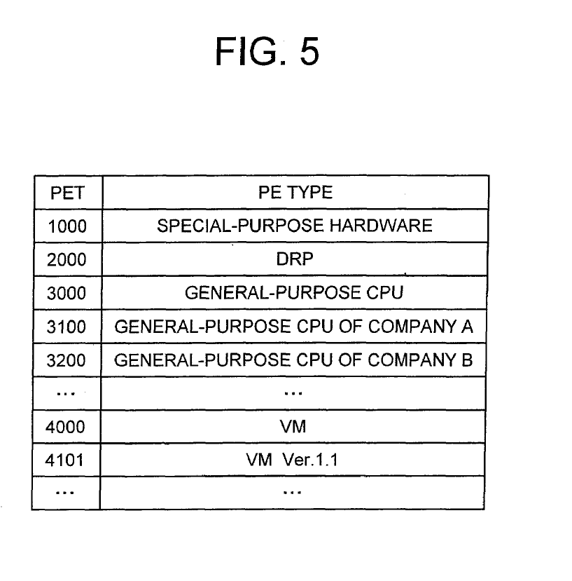

FIG. 5 shows examples of the processing element type. An example is a 64-bits CPU manufactured by Company A that can use instruction set XX.

The term “listing of libraries” refers to a listing showing the correspondence between library identifiers LID and factors such as (1) processing element types PET and (2) task identifiers TID by which the library identifiers LID are determined.

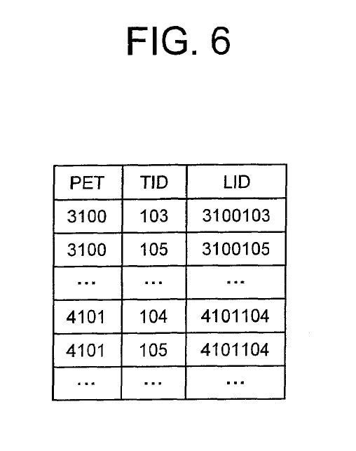

FIG. 6 shows an example of the listing of libraries. Here, the term “library identifier” (LID) refers to an identification number for identifying each program or reconfiguration information contained in the library. The library identifier is determined, for example, by (1) the processing element type (PET) and (2) the task identifier (TID) of the implemented task that are executable on the processing element.

When the control unit receives a program request from a processing element, a needed library identifier is searched for in the listing of libraries. Then, the program corresponding to the library identifier is sent to the processing element.

When (1) the processing element type and (2) the function identifier (FID) that are connected are identified, the library identifier corresponding thereto may be received from the listing of libraries.

The term “data” refers to information processed by the processing element PE, and includes, for example, images, sounds etc.

The term “task execution request” refers to a signal with which the control unit CU requests the first processing element in the order of execution, which may include the service execution requesting PE, to start execution of the task.

The term “completion of task execution” refers to a signal with which the last processing element in the order of execution, which may include the service execution requesting PE, notifies the control unit CU of completion of all the tasks.

The term “completion of service execution” refers to a signal with which the control unit CU notifies the service execution requesting processing element of completion of execution of the service.

The term “allocation of computational resource” refers to allocation, conducted by a processing element PE, of computational resources such as a computational power of a general-purpose processor, DRP, special-purpose hardware, and special-purpose software etc. and memory that are necessary in the processing of the service, to processing of a specific task. The term “deallocation of computational resource” refers to a process by which the computational resources that have been allocated are made available to processing of other services.

The term “allocation of processing path” refers to a process of enabling mutual communication of data relating to a task processing or the like with another processing element PE in one-to-one communication. The term “deallocation of processing path” refers to a process of closing the processing path to terminate the mutual communication with another processing element. When the term “deallocation” is used alone, it denotes both deallocation of computational resources and deallocation of processing path.

In the following, the basic configuration of data structure used in the embodiments will be described. This data structure is shown by way of example and the data structure is not limited to this structure. In the following example, a case in which seven processing elements PE are connected will be discussed, arbitrarily. One of the seven processing elements PE is a service execution requesting processing element PE1.

### (Processing Element Connection List)

Upon detecting the connection of a processing element PE, the control unit CU obtains information on this processing element PE. Then, the control unit CU creates a list for managing the processing elements PE connected to the control unit CU itself. This list will be referred to as a processing element connection list.

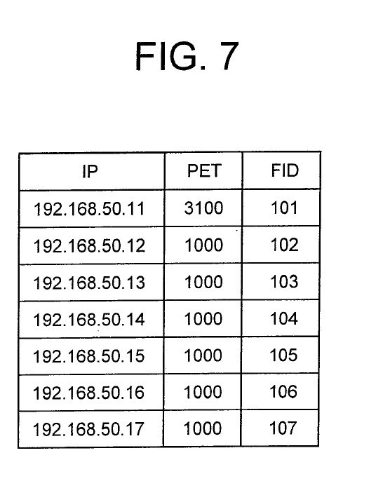

FIG. 7 shows a part of the processing element connection list. In the processing element connection list, for example, the IP addresses of the processing elements, the types of the processing elements (PET) and the function identifiers (FID), i.e. the identifiers of tasks executable by the respective processing elements are written, as shown in FIG. 7. In addition, the processing element connection list contains information on the connection start time, the bandwidth, and the memory capacity of the processing elements PE.

### (Task Execution Transition Table)

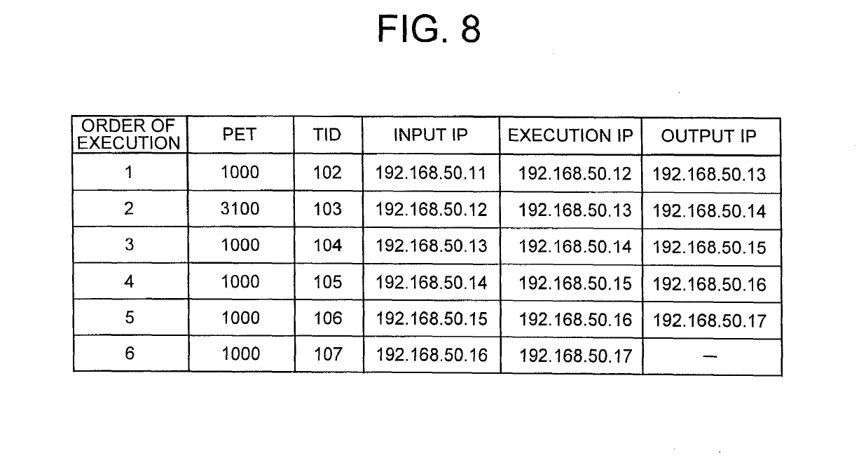

FIG. 8 shows an example of a task execution transition table. The task execution transition table is a specific form of the execution transition information. In this embodiment, the task execution transition table is a list in which the types of processing elements (PET) that perform input/output, the IP addresses (which will be herein after referred to as “IPs” arbitrarily) of processing elements PE that execute tasks, and the task identifiers are arranged in the order of execution. Specifically, in the task execution transition table, “task identifiers (TID)”, “input IPs”, “execution IPs”, and “output IPs are written in the order of execution. Here, the “input IP” refers to the IP of the processing element that inputs data. The “execution IP” refers to the IP of the processing element that executes the task. The “output IP” refers to the IP of the processing element that outputs data.

FIG. 1B shows the general configuration of the entire processing system including the control unit CU. The control unit CU includes an execution transition information control section, a library loading section, and a determination section.

In response to a request from a client, when the control unit CU detects the connection of a processing element PE, the determination section obtains information on the processing element PE and creates a processing element connection list as shown in FIG. 7.

When the determination section determines that the connection of a general-purpose processing element or a dynamic reconfigurable processor has been detected, the library identifier (LID) corresponding to the connected element is read out from the listing of libraries stored in the library and library information is obtained.

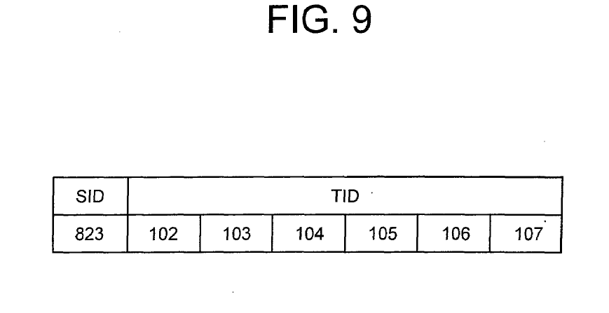

The execution transition information control section compares a service-task correspondence table as shown in FIG. 9 in which a request from a client is divided into tasks and the processing element connection list, to which the library information is added if need be, and determines to which PEs and in which order the tasks are to be assigned, and the IP addresses corresponding to the input and output PEs. The determination is summarized into execution transition information as shown in FIG. 8.

The control unit CU assigns the tasks to the processing elements PE based on the task execution transition table. Prior to execution of the tasks, the task execution transition table is given as path information to the processing elements PE1 to PE7 from the control unit CU.

The control unit CU creates the task execution transition table after the reception of a service execution request.

In order to request the execution of the assigned task, the control unit CU transmits the information written in each row of the above described task execution transition table, that is, the order of execution, the TID, the input IP, the execution IP, and the output IP, to each processing element as a task execution request in the following manner.

In doing so, the control unit CU has two modes of transmission of the task execution transition table, which include, as will be described later:

broadcast mode; and

sequential one-to-one mode (which will be herein after referred to as “one-to-one mode” arbitrarily).

### (Service-Task Correspondence Table)

FIG. 9 shows the configuration of a service-task correspondence table. The service-task correspondence table is a table in which the correspondence between a service and the tasks that constitute the service is indicated by means of identifiers.

The control unit CU obtains the service-task correspondence table from a server that manages the service task correspondence table at the time of initialization.

### Flow of Embodiment 1

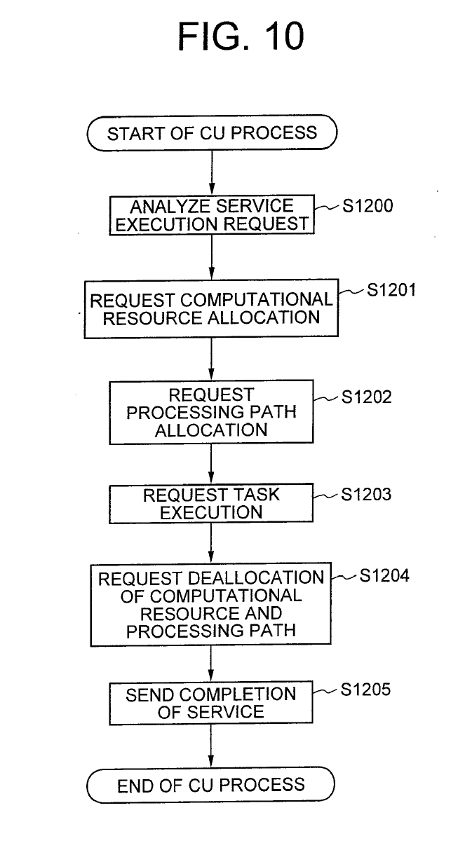

FIG. 10 is a flow chart of a basic control by the control unit CU. This flow cart only shows the basic flow and the detailed procedure will be described later.

In step S1200, the control unit CU receives a service execution request, analyzes it, and creates execution transition information.

In step S1201, the control unit CU makes a computational resource allocation request to a processing element(s) PE that allocates computational resources, if needed.

In step S1202, the CU makes a processing path allocation request to the processing elements PE, if needed.

In step S1203, the control unit CU sends a task execution request to a processing element PE.

In step S1204, the control unit CU sends a processing path deallocation request to the processing elements PE after receiving completion of task execution, if needed. The control unit CU makes, if needed, a computational resource deallocation request to the processing elements after receiving completion of processing path deallocation from the processing elements PE, and then receives completion of computational resource deallocation from the processing elements PE.

In step S1205, completion of the service is sent to the service execution requesting processing element PE.

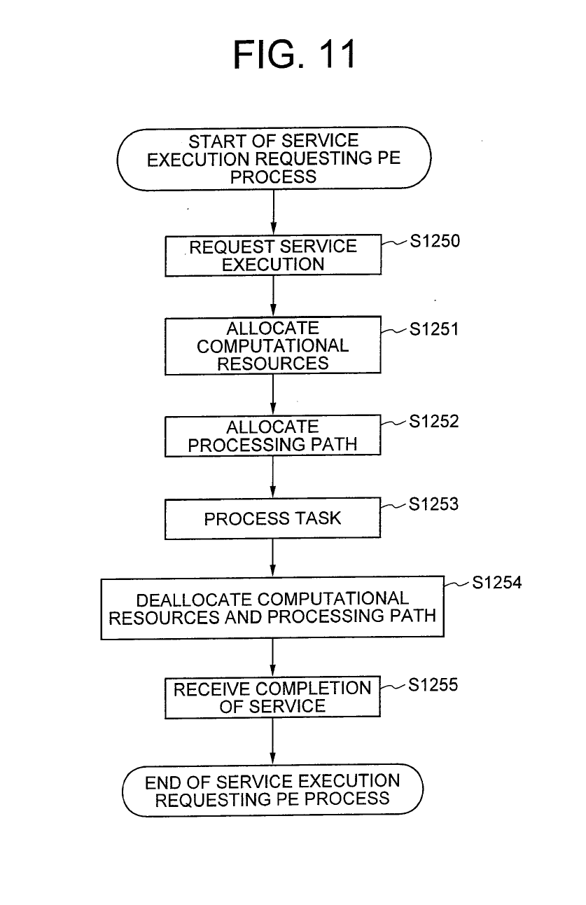

FIG. 11 is a flow chart of a basic control by the service execution requesting processing element PE.

In step S1250, the service execution requesting processing element PE makes a service execution request.

In step S1251, computational resources are allocated, if needed. In step S1252, a processing path(s) is allocated, if needed.

In step S1253, processing of the task(s) is performed, if needed, after allocation of the processing path(s). In step S1254, deallocation of the processing path(s) and deallocation of the computational resources are performed, if needed.

In step S1255, the service execution requesting PE1 receives a service completion signal. There may be cases where the service execution requesting processing element only requests a service but does not execute a task.

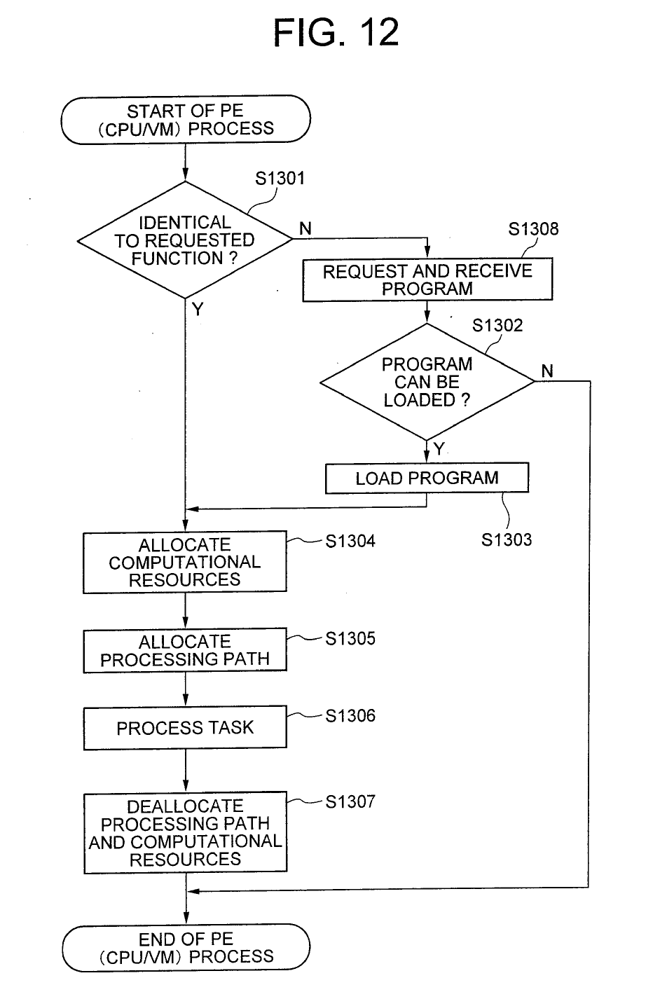

FIG. 12 is a basic flow chart of the processing element PE that is constituted of a general-purpose CPU or a virtual machine according to this embodiment.

In step S1301, a determination is made as to whether its own function at the time of reception and the requested function are identical or not.

If the determination in step S1301 is affirmative, allocation of computational resources is performed in step S1304.

In step S1305, a processing path(s) is allocated in response to the request from the CU.

In step S1306, task processing is performed. In step S1307, deallocation of the processing path(s) and deallocation of the computational resources are performed in response to a request from the CU.

If the determination in step S1301 is negative, a program is requested from the control unit CU and the program is received in step S1308. In step S1302, a determination is made as to whether the program for implementing the requested function can be loaded or not.

If the determination in step S1302 is affirmative, the program is loaded in step S1303.

Then, the process proceeds to step S1304. If the determination in step S1302 is negative, the process is terminated.

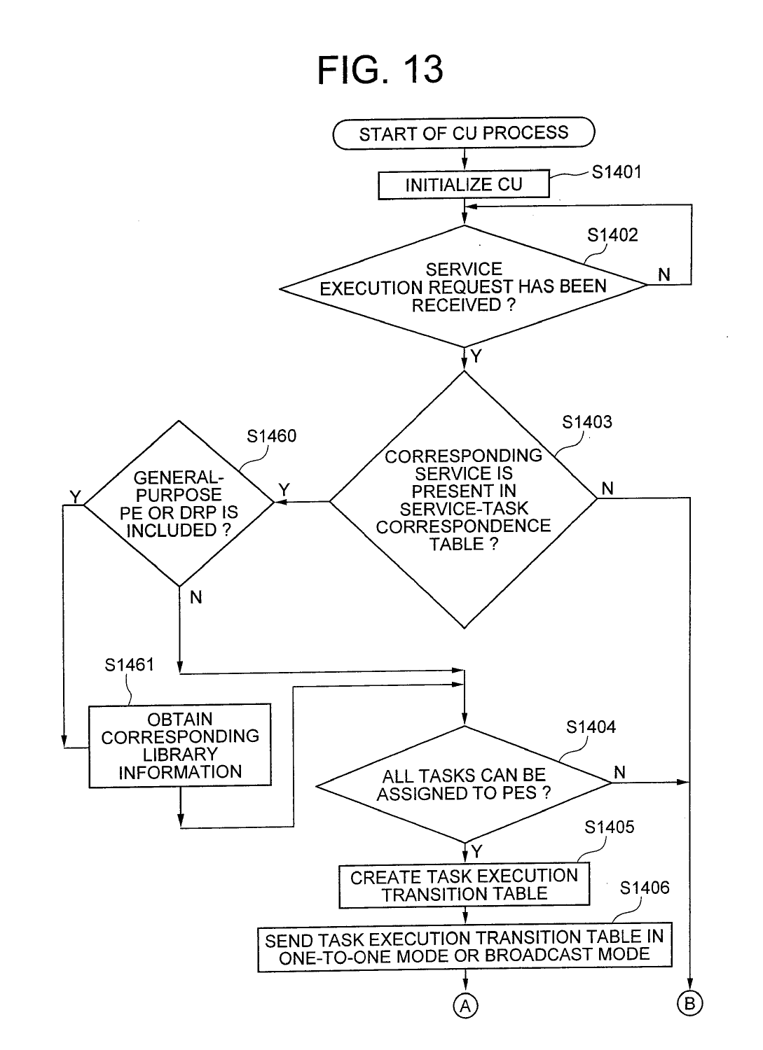

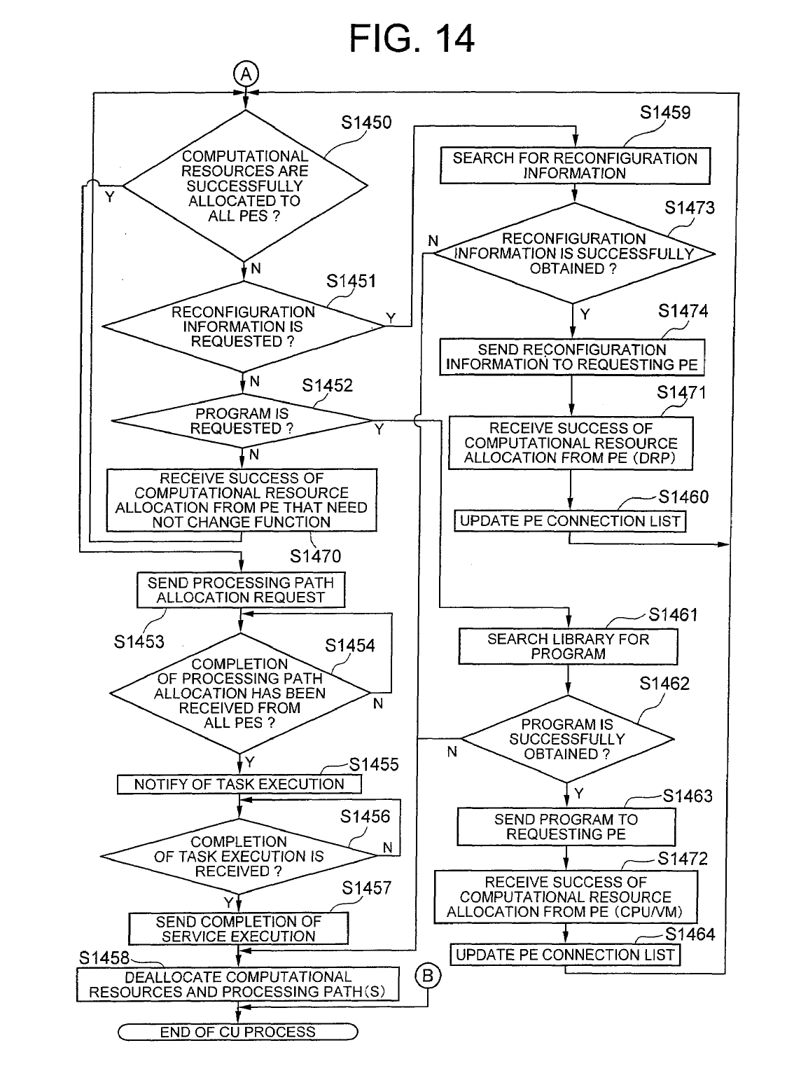

FIGS. 13 and 14 are flow charts for describing the detailed procedure of the control by the control unit.

In step S1401, the control unit CU is initialized. In step S1402, a determination is made as to whether the control unit CU has received a service execution request or not.

If the determination in step S1402 is negative, the process of step S1402 is executed repeatedly.

If the determination in step S1402 is affirmative, a determination is made, in step S1403, as to whether the service corresponding to the received service is included in the service task correspondence tables or not. If the determination in step S1403 is negative, the control unit CU terminates the process.

If the determination in step S1403 is affirmative, the processing element types PET in the processing element connection list is read out, and a determination is made as to whether a general-purpose processing element(s) or a dynamic configurable processing element(s) is included or not, in step S1460. If the determination in step S1460 is negative, the process proceeds to step S1404.

If the determination in step S1460 is affirmative, in step S1461, the listing of libraries is read out, and the library information corresponding to the PETs read out in step S1460 is obtained. Then, the process proceeds to step S1404.

If the determination in step S1460 is negative, or after step S1461, a determination is made, in step 1404, as to whether all the tasks can be assigned to the processing elements PE or not, based on the TIDs included in the corresponding service-task correspondence table, the FIDs included in the processing element connection list, and the library information corresponding to the PETs read out in step S1460. If the determination in step S1404 is affirmative, the control unit CU creates a task execution transition table, in step S1405. If the determination in step S1404 is negative, the control unit CU terminates the process.

In step S1406, the task execution transition table is transmitted to the processing element PE in either the one-to-one mode or the broadcast mode.

Next, a further description will be made with reference to FIG. 14. In step S1450, a determination is made as to whether computational resources of all the processing elements PE have been successfully allocated or not. If the determination in step S1450 is affirmative, a processing path allocation request is sent in step S1453. In step S1454, a determination is made as to whether processing path allocation completion signals have been received from all the processing elements PE or not.

If the determination in step S1454 is affirmative, a task execution request is notified to the first processing element PE in the order of execution, in step S1455. In step S1456, a determination is made as to whether or not completion of task execution has been received from the last processing element PE in the order of execution. If the determination in step S1454 is negative, the process of step S1454 is executed repeatedly.

If the determination in step S1456 is affirmative, completion of service execution is sent to the service execution requesting processing element PE1, in step S1457. In step S1458, deallocation of the computational resources and deallocation of the processing path(s) are performed. Then, the control unit CU terminates the process. If the determination in step S1456 is negative, the process of step S1456 is executed repeatedly.

If the determination in step S1450 is negative, a determination is made, in step S1451, as to whether reconfiguration information for a dynamic reconfigurable processor(s) (DRP) has been requested or not. If the determination in step S1451 is affirmative, the reconfiguration information is searched for in the library, in step S1459. In step S1473, a determination is made as to whether the reconfiguration information has been successfully obtained or not. If the determination in step S1473 is affirmative, the reconfiguration information is sent, in step S1474, to the processing element(s) PE that has requested the reconfiguration information. In step S1471, success of computational resource allocation is received from the PE (DRP), and in step S1460, the processing element connection list is updated. Then, the process returns to step S1450. If the determination in step S1473 is negative, the process proceeds to step S1458.

If the determination in step S1451 is negative, a determination is made, in step S1452, as to whether a program(s) has been requested or not. If the determination in step S1452 is affirmative, the program(s) is searched for in the library, in step S1461. In step S1462, a determination is made as to whether the program(s) has been successfully obtained or not. If the determination in step S1452 is negative, success of computational resource allocation is received, in step S1470, from a processing element(s) PE that does not need to change its function, and the process returns to step S1450.

If the determination in step S1462 is affirmative, the program(s) is sent to the processing element(s) PE that has requested the program, in step S1463. In step S1472, success of computational resource allocation is received from the PE (general-purpose CPU or virtual machine), and in step S1464, the processing element connection list is updated. If the determination in step S1462 is negative, the process proceeds to step S1458.

In step S1458, deallocation of the computational resources and deallocation of the processing path(s) are performed. Then, the control unit CU terminates the process.

### (Control Flow of PE)

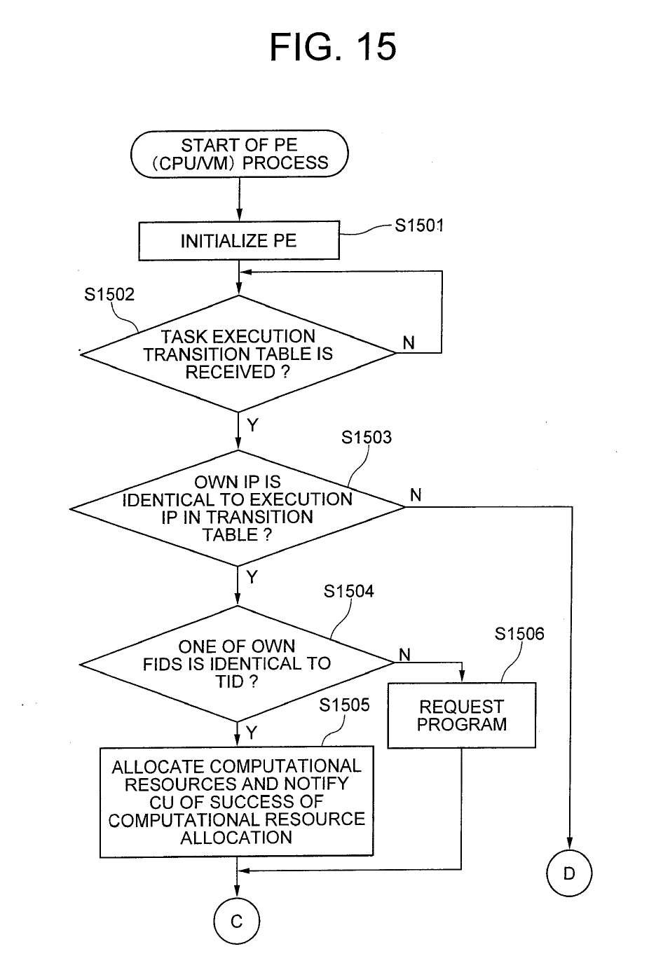

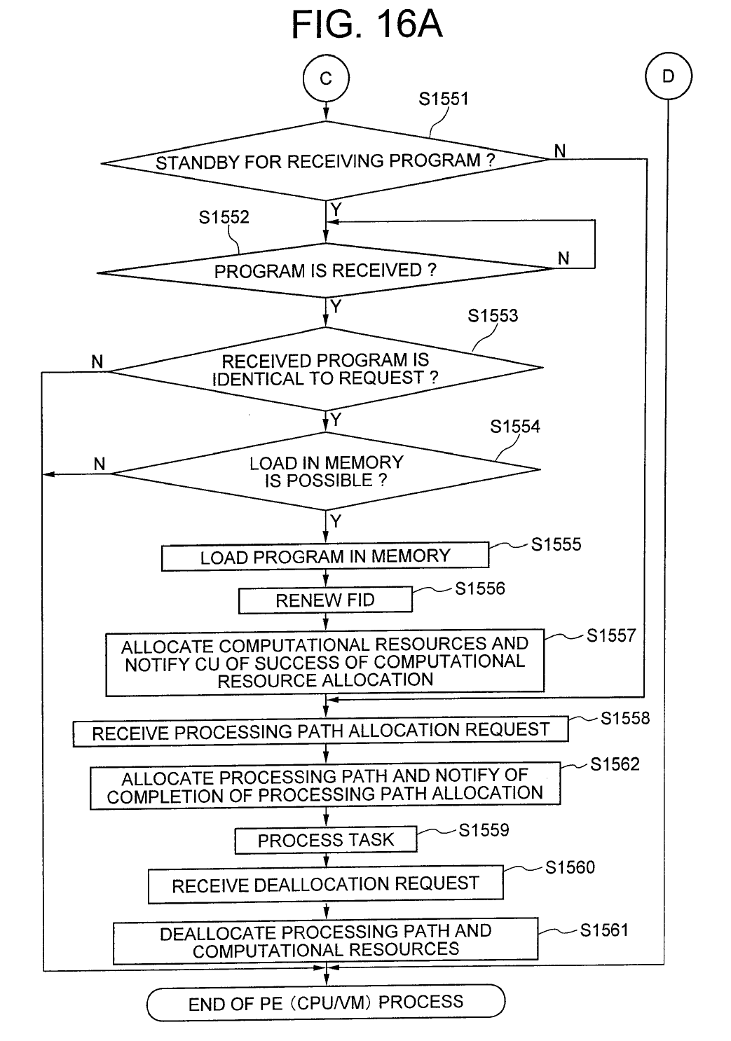

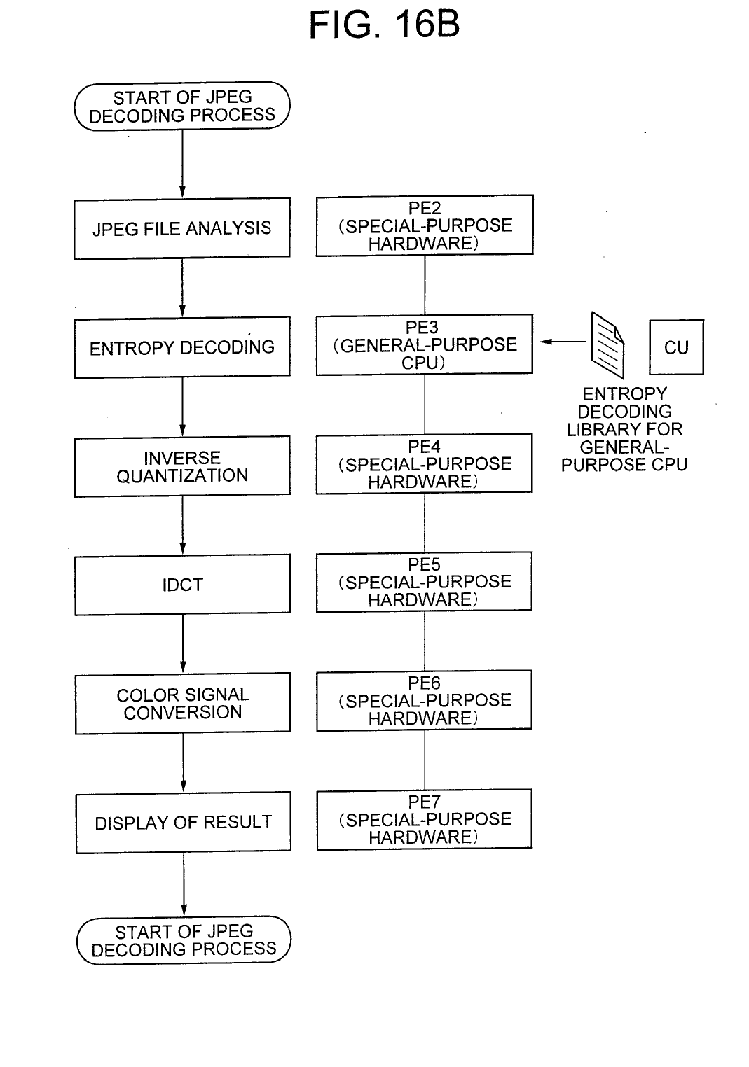

FIGS. 15 and 16A are flow charts describing the procedure of a control in the processing element PE that is constituted of a general-purpose CPU or a virtual machine according to this embodiment. Here, a description of the process in the case where the general-purpose CPU or the virtual machine (VM) is used as a service execution requesting processing element will be omitted, and only the implementation of general functions will be described.

In step S1501 shown in FIG. 15, the processing element PE is initialized. In step S1502, a determination is made as to whether the processing element PE has received a task execution transition table or not.

If the determination in step S1502 is affirmative, a determination is made, in step S1503, as to whether the IP address of the processing element PE itself and the execution IP address are identical or not. If the determination in step S1502 is negative, the process of step S1502 is executed repeatedly.

If the determination in step S1503 is affirmative, a determination is made, in step S1504, as to whether one of the FIDs of the processing element PE itself is identical to the TID or not. If the determination in step S1503 is negative, the processing element PE terminates the process.

If the determination in step S1504 is affirmative, computational resources are allocated, and success of computational resource allocation is notified to the control unit CU, in step S1505. Then, the process proceeds to step S1551. If the determination in step S1504 is negative, a program is requested from the control unit CU in step 1506. Then, the process proceeds to step S1551.

In step S1551, a determination is made as to whether the processing element PE is in a standby state for receiving the program or not. If the determination in step S1551 is negative, a processing path allocation request is received in step S1558. In step S1562, a processing path(s) is allocated, and completion of processing path allocation is notified to the control unit CU. In step S1559, processing of the task is performed. In step S1560, a deallocation request is received. In step 1561, deallocation of the processing path(s) and deallocation of the computational resources are performed. Then, the processing element PE terminates the process.

If the determination in step S1551 is affirmative, a determination is made, in step S1552, as to whether the program has been received or not. If the determination in step S1552 is affirmative, in step S1553, a determination is made as to whether the received program is identical to the requested program or not.

If the determination in step S1553 is affirmative, a determination is made, in step S1554, as to whether the received program can be loaded into the memory or not. If the determination in step S1554 is affirmative, the program is loaded into the memory in step S1555. In step S1556, the FID is renewed. In step S1557, computational resources are allocated, and success of computational resource allocation is notified to the control unit CU. Then, in step S1559, processing of the task is performed.

If the determination in step S1552 is negative, the process of step S1552 is executed repeatedly. If the determination in step S1553 is negative, the process is terminated. If the determination in step S1554 is negative, the process is terminated.

### (Example of JPEG Decoding Process)

Next, a flow of a JPEG decoding process according to a processing model shown in FIG. 2 will be described in chronological order.

FIG. 16B shows a correspondence between a flow of a JPEG decoding process and the system configuration in this embodiment. In this embodiment, the CU causes the processing element PE3 that is constituted of a general-purpose CPU to dynamically download software that provides the entropy decoding function from a library, and causes the general-purpose CPU to execute the entropy decoding task, to thereby achieve a part of the JPEG decoding process. The other functions are executed by special-purpose hardware in the processing elements PE2 and PE4 to PE7. The special-purpose hardware may be replaced by special-purpose software.

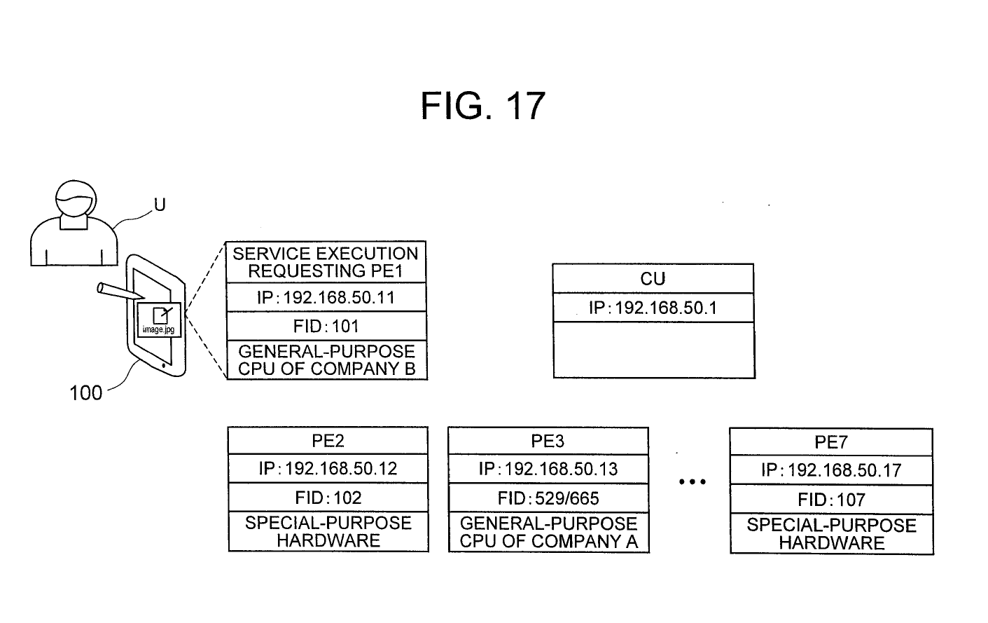

FIG. 17 shows the system configuration in this embodiment. In this embodiment, a case in which a user U causes a JPEG image named “image.jpeg” to be displayed on the processing element PE7 by entering a command through a portable terminal 100 will be discussed. When the user U designates a file, JPEG decoding is performed by distributed processing on the PE network, and the result is displayed on PE7.

Among the processing elements PE1 to PE7 connected to the control unit CU, the processing element PE3 is a general-purpose CPU manufactured by Company A.

### (Presupposition)

The following conditions are presupposition.

The user U has the portable device 100 provided with a processing element PE. This processing element PE can perform, as a service execution requesting processing element (or client), at least the following functions.

The processing element PE can recognize a request from the user U.

The processing element PE can make a service execution request to the control unit CU.

The processing element PE can read a JPEG file and send image data to other processing elements PE.

The control unit CU and the processing elements PE have completed necessary initialization processes.

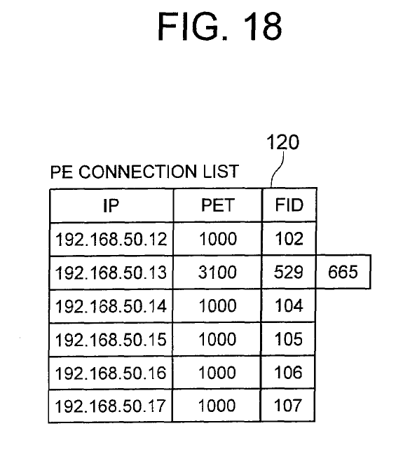

The control unit CU has detected the connection of the processing elements PE and has already updated the PE connection list (i.e. has obtained the types of the PEs (PET) and FIDs). FIG. 18 shows the PE connection list preserved in the control unit CU in the embodiment.

The control unit CU has been informed that the image should be output to PE7.

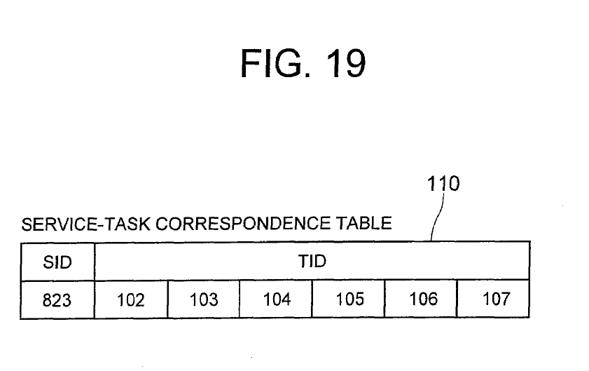

The control unit CU has already obtained a service-task correspondence table corresponding to the JPEG decoding process. FIG. 19 shows this service-task correspondence table.

The control unit CU has already obtained a dynamic processing library for executing all the steps of the JPEG decoding process (steps S101 to S106) entirely from a server. The dynamic processing library has already been compiled into a form that can be executed by each of the processing elements PE and linked. However, the library may be dynamically obtained at the time of execution.

Each of the processing elements PE has already obtained its own IP address and the IP of the control unit CU.

The following cases are not taken into particular consideration:

a case in which a processing element executes two or more tasks;

a case in which the control unit CU makes a query to another control unit CU for information on the processing elements PE; and

minor error processing.

### (User Processing Request)

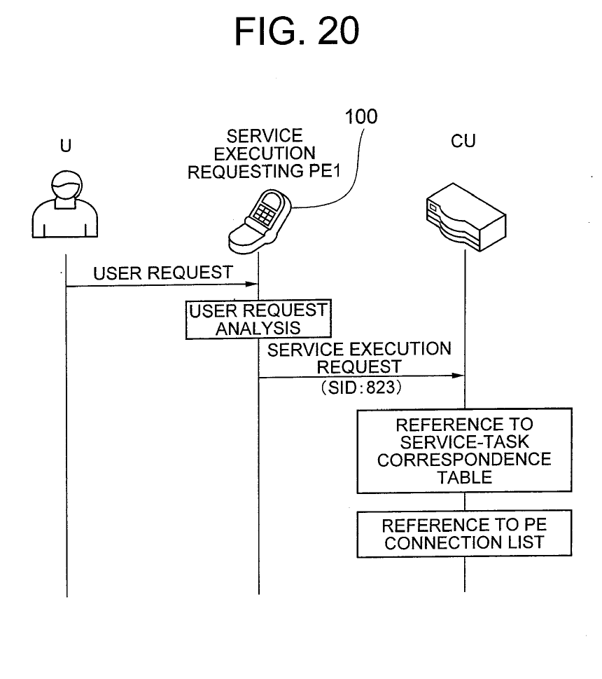

In FIG. 20, firstly, the user U requests display of a JPEG file by, for example, double-clicking the icon of “image.jpeg file” on the portable terminal 100.

The portable terminal 100 determines that a JPEG file decoding process is needed. Thus, the service execution requesting processing element PE1 sends a service execution request for the JPEG decoding process (SID: 823) to the control unit CU.

Upon receiving the service execution request, the control unit CU refers to a service-task correspondence table 110 based on the service identifier (SID) 823 representing the JPEG decoding. Then, the control unit CU obtains the tasks required for the service and the order of execution of the tasks based on the service identifier 823.

The control unit CU determines whether assignment of the tasks and execution of the service can be achieved or not with reference to the processing element connection list 120.

If it is determined that the service can be executed, the process proceeds.

If it is determined that the service cannot be executed, the control unit CU returns error information to the service execution requesting processing element PE1.

### (Broadcast Mode)

The control unit CU creates a task execution transition table 130 in which the assignment of the task executions and the execution order are written.

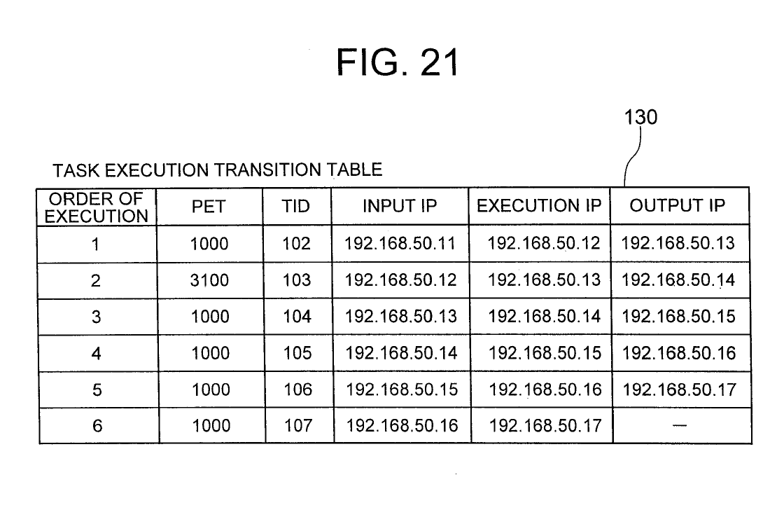

FIG. 21 shows the task execution transition table according to this embodiment. There are the broadcast mode and the one-to-one mode in which the task execution transition table and control information such as a processing path allocation request are transmitted.

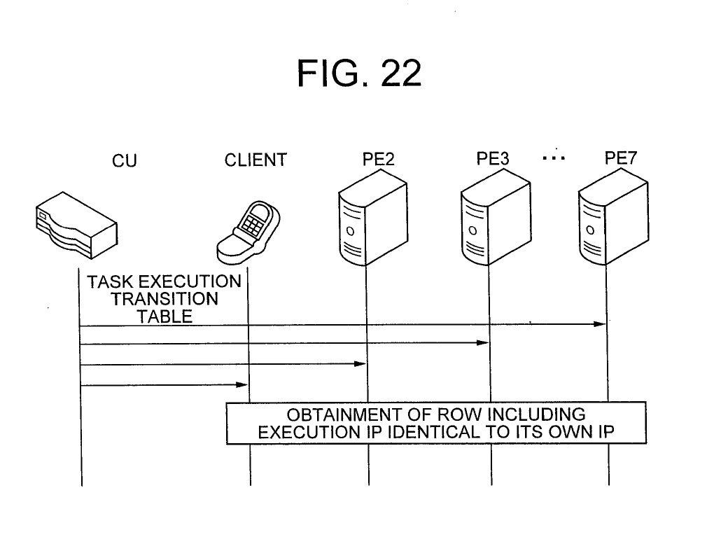

FIGS. 22, 23, 24, and 25 are diagrams illustrating the broadcast mode according to this embodiment. In the other embodiments also, a task execution transition table and control information can be transmitted to processing elements or clients in the broadcast mode.

In FIG. 22, after the creation of the task execution transition table, the control unit CU broadcasts the task execution transition table to all the processing elements PE. Upon receiving the task execution transition table 130, each processing element PE obtains only information in the row including an execution IP identical to its own IP. If there is no row including an execution IP address identical to its own IP address in the task execution transition table 130, the processing element PE returns an error to the control unit CU.

In this embodiment, herein after, the task execution transition table issued by the control unit CU provides the function of a computational resource allocation request.

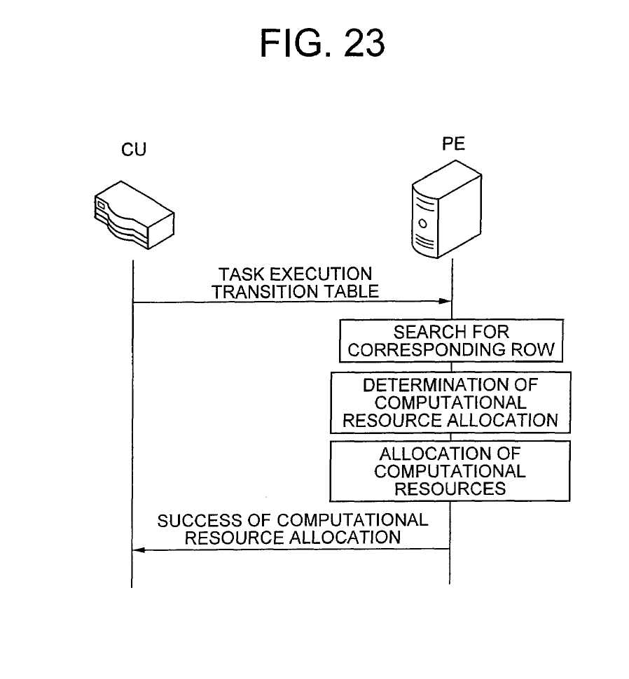

FIG. 23 shows a sequence of allocation of computational resources in the broadcast mode in the case where the processing element PE is constituted of special-purpose hardware. When the requested TID is identical to its own FID, the processing element PE2, PE4, PE5, PE6, PE7 constituted of special-purpose hardware allocates the computational resources necessary for the task processing, and returns success of computational resource allocation to the control unit CU. If the processing element cannot provide the function necessary for the requested task processing, the processing element returns an error.

### (Allocation of Resources)

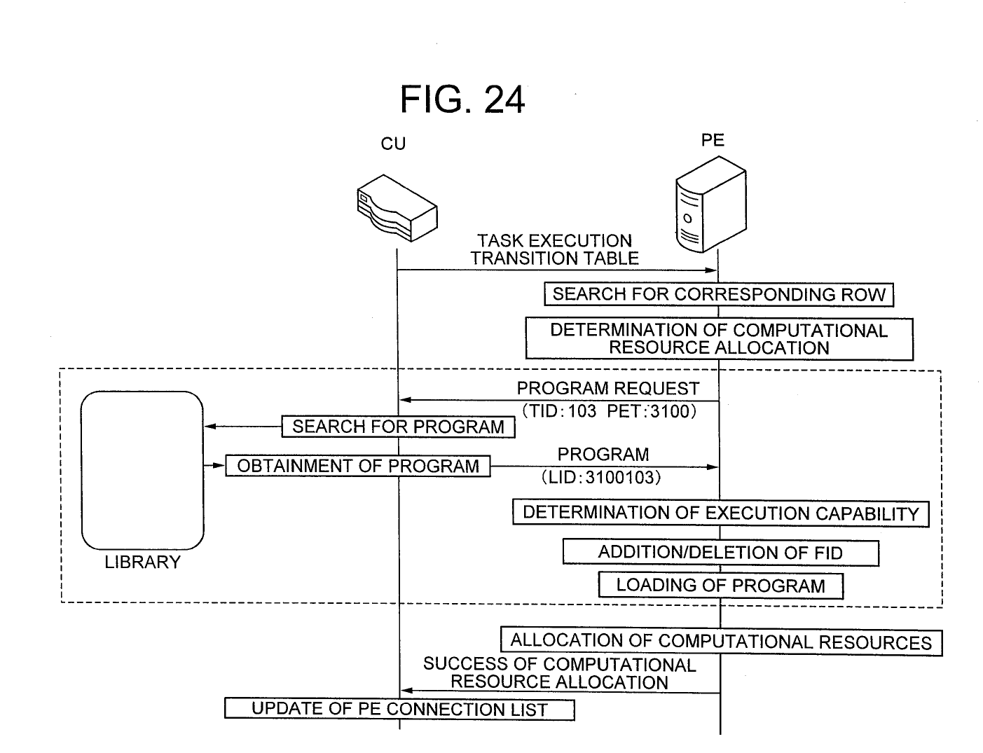

FIG. 24 shows a sequence of allocation of computational resources in the broadcast mode in the case where the processing element PE is a general-purpose CPU. If the requested TID is identical to one of its own FIDs, the processing element PE constituted of a general-purpose CPU allocates the computational resources necessary for the task processing without executing the process shown in the frame drawn by the broken line, and returns success of computational resource allocation to the control unit CU. If the processing element PE cannot provide the function necessary for the requested task processing, the processing element PE proceeds to the process shown in the frame drawn by the broken line, and returns a program request to the control unit CU.

Upon receiving the program request, the control unit CU searches the library for the corresponding program having the identical PET and the identical TID. Then, the control unit CU transmits the obtained program to the processing element PE.

Upon receiving the program, the processing element PE3 determines whether the program can be executed or not in view of matching of the program with the required function and the available memory space. If it is determined that the program cannot be executed, the processing element PE3 returns an error to the control unit CU. After the unnecessary program and the corresponding FID are deleted, if necessary, the FID of the program to be newly introduced is added and the program is loaded into the memory. Thereafter, the processing element PE sends success of computational resource allocation to the control unit CU.

In this embodiment, the PE3 deletes the program that implements the function having an FID of 665, and newly loads the program that implements the function having an FID of 103. At this time, the control unit CU updates the processing element connection list 120.

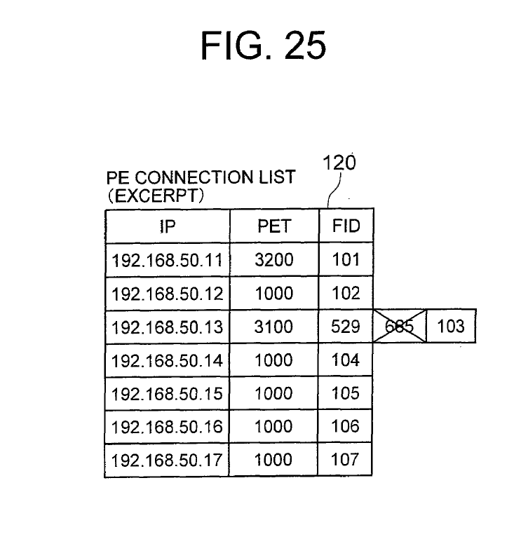

FIG. 25 shows a state of the processing element connection list 120 after the update.

In the case where the processing element PE is a virtual machine, the dynamic processing library includes a program corresponding to a virtual processing section that a general-purpose processing element has.

### (Allocation of Processing Path)

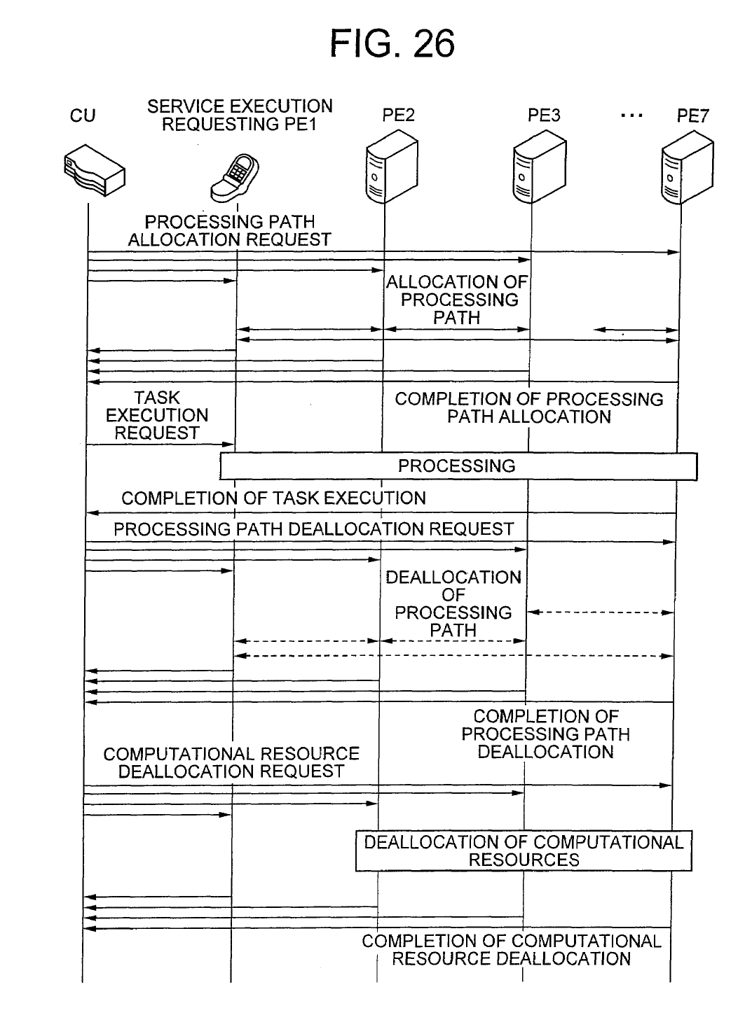

In FIG. 26, after receiving success of computational resource allocation from the processing elements PE, the control unit CU broadcasts a processing path allocation request to all the processing elements PE in which processing path allocation is needed. All the processing elements PE that have received the processing path allocation request allocate the processing paths all at once and notify the control unit CU of completion of processing path allocation. The control unit CU sends a task execution request to the service execution requesting PE1, and then the service execution requesting PE1 starts the process.

After completion of the data processing, the processing element PE7 sends completion of task execution to the control unit CU. The control unit CU broadcasts a processing path deallocation request to all the processing elements PE in which deallocation of the processing path(s) is needed. The processing elements PE that have received the processing path deallocation request deallocate the processing paths all at once and notify the control unit CU of completion of processing path deallocation.

After receiving all the completions of processing path deallocation, the control unit CU broadcasts a computational resource deallocation request to all the processing elements PE in which deallocation of the computational resources is needed. The processing elements PE that have received the computational resource deallocation request deallocate the computational resources simultaneously and notify the control unit CU of completions of computational resource deallocation.

### (One-to-One Mode)

Next, the one-to-one mode that is different from the above described broadcast mode will be described. In the one-to-one mode, the control unit CU transmits, to all the processing elements PE it manages, respective corresponding portions of the task execution transition table 130 and control information. In other words, the control unit transmits the task execution transition table 130 in such a way that the control unit CU is in one-to-one relationship with each processing element PE. In the other embodiments also, the task execution transition table and control information may be transmitted to a processing element(s) or a client(s) in the one-to-one mode.

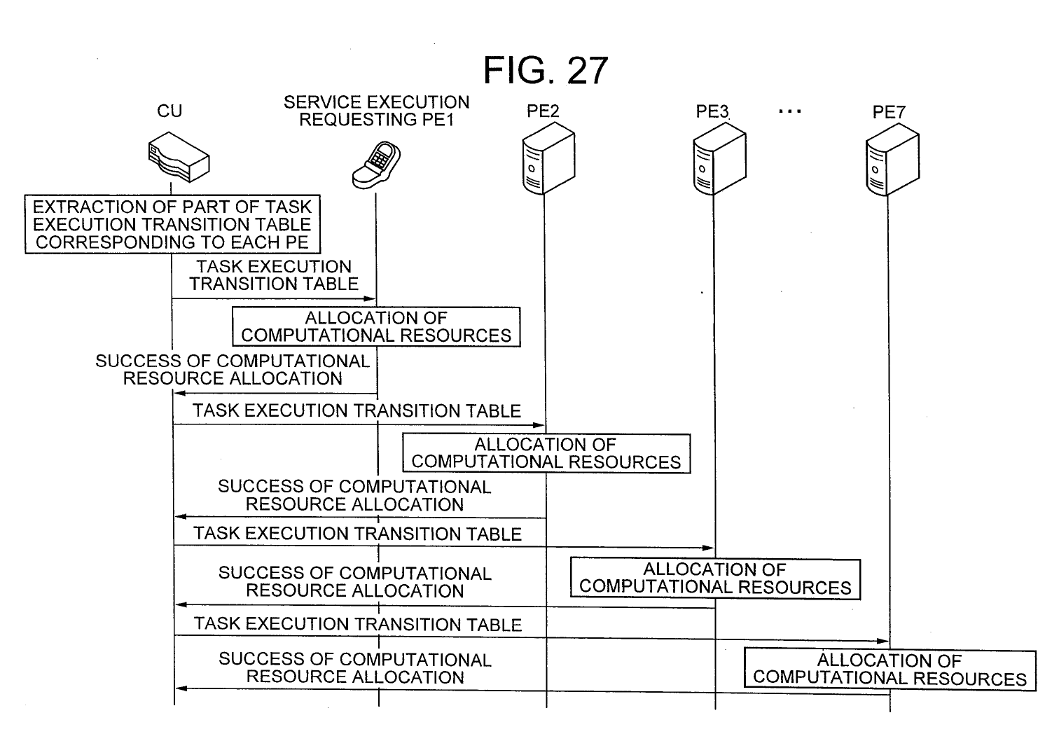

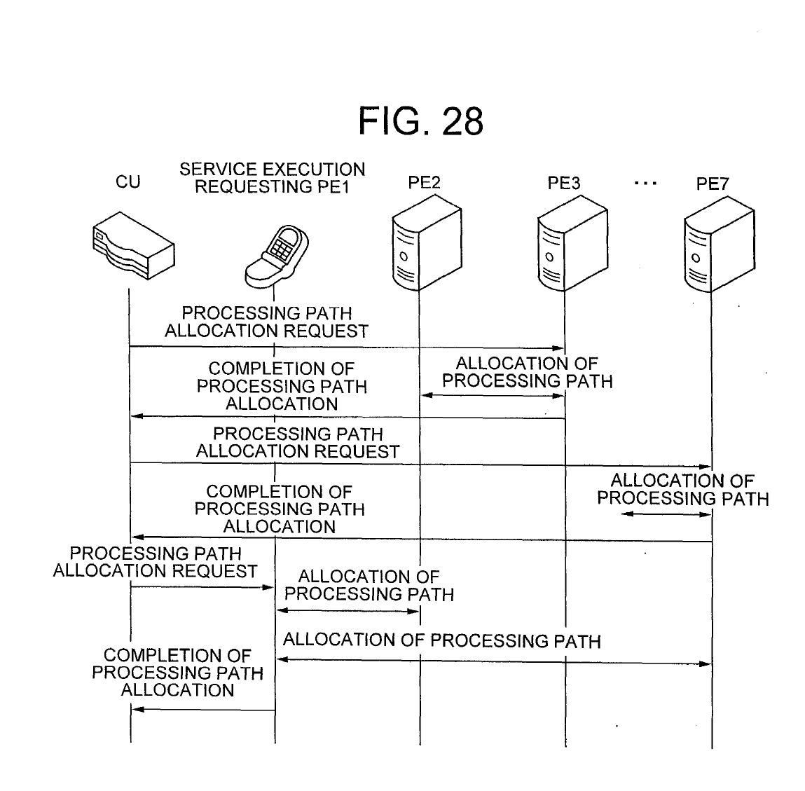

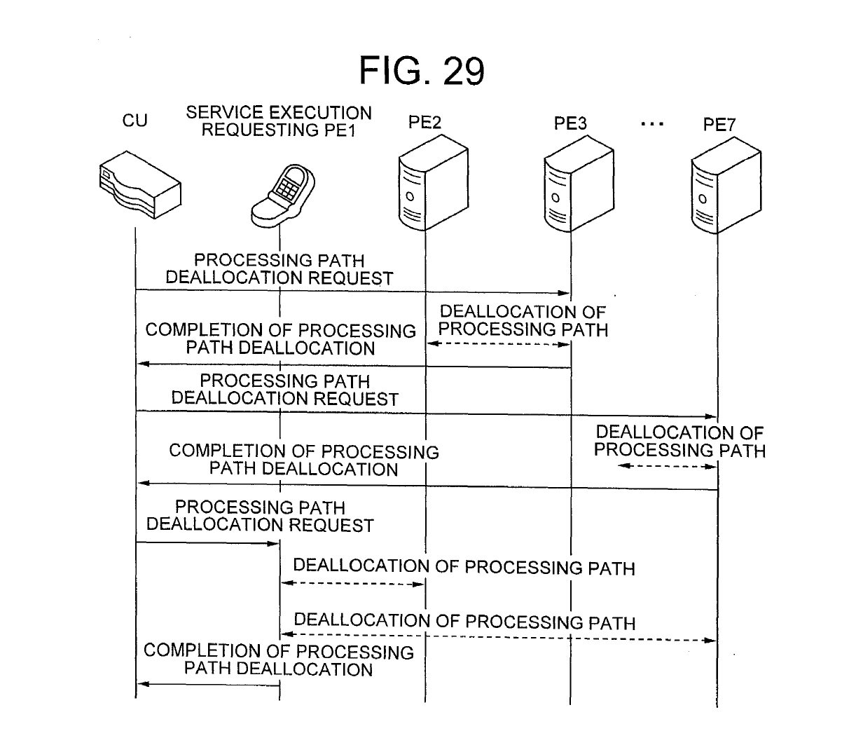

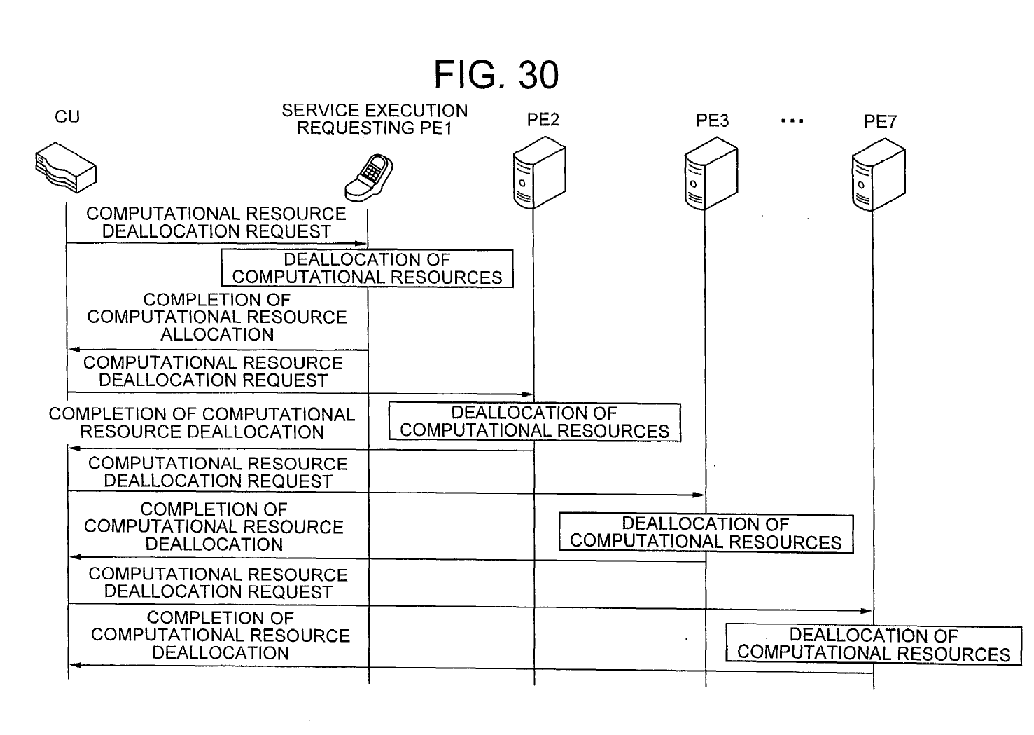

FIGS. 27, 28, 29, and 30 are diagrams illustrating the one-to-one mode. In the one-to-one mode, the control unit CU may transmit the entire task execution transition table 130 to each processing element PE. In this case,

(a) after receiving the task execution transition table 130, each processing element PE obtains only information in the row including an execution IP identical to its own IP, and

(b) if there is no row including an execution IP address identical to its own IP address in the task execution transition table 130, the processing element PE returns an error to the control unit CU.

### (Allocation of Computational Resources)

As is the case in the broadcast mode, each processing element PE sends success of computational resource allocation to the control unit CU if the computational resources can have been allocated. If the computational resources cannot be allocated, the processing element PE requests a program that implements the corresponding function or returns an error.

### (Path Allocation Request and Allocation of Path)

After receiving success of computational resource allocation from the processing elements PE, the control unit CU sends a processing path allocation request to each of the processing elements PE in which processing path allocation is needed one by one. The processing element PE that has received the processing path allocation request allocates a processing path(s) and notifies the control unit CU of completion of processing path allocation. The above described sequence is repeated multiple times, equal to the number of the processing elements PE that are needed. The control unit CU sends a task execution request to the service execution requesting PE1, and then the service execution requesting PE1 starts the processing.

After completion of the data processing, the processing element PE7 sends completion of task execution to the control unit CU. The control unit CU sends a processing path deallocation request each of the processing elements PE in which processing path deallocation is needed. The processing element PE that has received the processing path deallocation request deallocates the processing path(s) and notifies the control unit CU of completion of processing path deallocation. The above described sequence is repeated multiple times, equal to the number of the processing elements PE that are needed.

After receiving all the completions of processing path deallocation, the control unit CU sends a computational resource deallocation request to each of the processing elements PE in which computational resource deallocation is needed. The processing element PE that has received the computational resource deallocation request deallocates the computational resources and notifies the control unit CU of completion of computational resource deallocation. The above described sequence is repeated multiple times, equal to the number of the processing elements PE that are needed.

The above described allocation and deallocation of computational resources and allocation and deallocation of processing paths are also executed sequentially from one processing element PE to another. In the one-to-one mode, it can be traced until which processing element PE the allocation of computational resources and processing paths and the deallocation of computational resources and processing paths can be executed.

### (Combination of Broadcast Mode and One-to-One Mode)

In allocation of computational resources and in allocation of processing paths, the one-to-one mode and the broadcast mode can be used in combination with each other. Furthermore, there are cases where allocation of computational resources is not performed. Thus, there can be the following seven patterns of combination.

| | computational resource | processing path |
|---|---|---|
| Pattern | allocation | allocation |
| 1 | broadcast | broadcast |
| 2 | broadcast | one-to-one |
| 3 | one-to-one | broadcast |
| 4 | one-to-one | one-to-one |
| 5 | not performed | broadcast |
| 6 | not performed | one-to-one |
| 7 | not performed | not performed |

For example, in a case where processing elements PE are to be allocated as computational resources, they may be allocated all at once, or only the computational resources necessary for some of the tasks constituting the service may be allocated if a part of the previously executed service can be commonly used. There may be cases where allocation of computational resources is not necessary. In the case of the processing path allocation also, there may be cases in which all the processing paths need to be allocated all at once, and cases in which it is sufficient to reconfigure some of the processing paths.

Next, the patterns will be described. In the following descriptions, N>M (N and M are integers) implies that the reception of the service execution request for service N is posterior to the reception of the service execution request for service M. For example, the reception of the service execution request for service 2 is posterior to the reception of the service execution request for service 1. Tasks A to E refer to the tasks executed by the processing elements PE.

### (Pattern 1)

In pattern 1, allocation of computational resources is performed in the broadcast mode, and allocation of processing paths is performed in the broadcast mode. Pattern 1 is a basic pattern, and allocation of computational resources and allocation of processing paths are normally performed in pattern 1. The process in pattern 1 is efficient, because all the allocation processes can be performed at once.

### (Pattern 2)

In pattern 2, allocation of computational resources is performed in the broadcast mode, and allocation of processing paths is performed in the one-to-one mode. Normally, it is not needed to employ pattern 2. However, the pattern 2 is effectively employed in cases where the allocations of processing paths are to be traced one by one to monitor only the status of the paths.

### (Pattern 3)

In pattern 3, allocation of computational resources is performed in the one-to-one mode, and allocation of processing paths is performed in the broadcast mode. A specific example is shown below.

Service 1: task A→B→C
Service 2: task A→C→D→B

In this case, service 2 only lacks the computational resources for executing the task D as compared to service 1. However, the processing paths are totally different, and therefore all the processing paths are deallocated after execution of service 1. It is efficient to allocate, thereafter, computational resource D in the one-to-one mode and allocate the processing paths for service 2 in the broadcast mode.

There is another case in which pattern 3 is effectively employed. That is, pattern 3 is effectively employed in cases where only the allocations of computational resources are to be traced one by one to monitor only the status of the computational resources.

### (Pattern 4)

In pattern 4, allocation of computational resources is performed in the one-to-one mode, and allocation of processing paths is performed in the one-to-one mode. A specific example is shown below.

Service 1: task A→B→C
Service 2: task A→B→D
Service 3: task E→B→D

In this case, service 2 uses a part of service 1 (i.e. task A and task B), and service 3 uses a part of service 2 (i.e. task B and task D). In this case, allocation of the computational resources of task D in service 2 is performed in the one-to-one mode, and allocation of the processing path B-D is performed in the one-to-one mode. Similarly, allocation of computational resources of task E in service 3 is performed in the one-to-one mode, and allocation of processing path between E and B is performed in the one-to-one mode.

In this way, the computational resources and the processing paths can be partly rearranged. In addition, by employing the one-to-one mode, it can be traced until which computational resource the computational resource allocation has progressed and until which processing path the allocation has progressed. Therefore, the status of allocation of the computational resources and the processing paths and the occurrence of errors can be monitored point by point.

### (Pattern 5)

In pattern 5, allocation of computational resources is not performed, and allocation of processing paths is performed in the broadcast mode. A specific example is shown below.

Service 1: task A→B→C→D
Service 2: task A→C→D→B.

This combination pattern is effective in cases where service 2 uses all the processing elements PE used in service 1 without a change and the processing paths are totally different.

### (Pattern 6)

In pattern 6, allocation of computational resources is not performed, and allocation of processing paths is performed in the one-to-one mode. A specific example is shown below.

Service 1: task A→B→C→D
Service 2: task A→B→D

Service 2 can be constituted only by tasks constituting service 1, and service 2 can be constituted only by partly rearranging the processing paths in the service 1. In this case, in service 2, only allocation of a processing path is performed in the one-to-one mode. Even in cases where a number of changes in the processing paths are to be made, this pattern may be employed if the status of allocation of the processing paths or errors are desired to be traced as described above.

### (Pattern 7)

In pattern 7, neither allocation of computational resources nor allocation of processing path is performed. A specific example is shown below.

Service 1: task A→B→C→D
Service 2: task A→B→C

This is a case in which service 2 can be provided only by deallocating a part of the computational resources and the processing paths in service 1.

In addition to the above described seven patterns, there are the following two patterns. However, if computational resources are newly allocated without allocation of processing paths, the computational resources cannot be used. Therefore, practically, there are no cases where the following patterns are employed.

| | computational resource | processing path |
|---|---|---|
| Pattern | allocation | allocation |
| 8 | broadcast | not performed |
| 9 | one-to-one | not performed |

### (Combination of Broadcast Mode and One-to-One Mode)

Similarly, in deallocation of computational resources and in deallocation of processing paths, the one-to-one mode and the broadcast mode can be used in combination. There are cases where deallocation of computational resources is not performed. Thus, there can be the following seven patterns of combination.

| | computational resource | processing path |
|---|---|---|
| Pattern | deallocation | deallocation |
| 11 | broadcast | broadcast |
| 12 | broadcast | one-to-one |
| 13 | one-to-one | broadcast |
| 14 | one-to-one | one-to-one |
| 15 | not performed | broadcast |
| 16 | not performed | one-to-one |
| 17 | not performed | not performed |

For example, in a case where the processing elements PE that have been allocated as computational resources are to be deallocated, they may be deallocated all at once, or only some of the computational resources that are not needed in subsequent tasks may be deallocated if some of the allocated computational resources can also be used in a service to be executed subsequently. There may be cases where deallocation of computational resources is not necessary. In the case of deallocation of processing paths also, there may be cases in which all the processing paths need to be deallocated simultaneously, or cases in which it is sufficient to deallocate some of the processing paths.

Next, the patterns will be described. In the following descriptions, N>M (N and M are integers) implies that the reception of the service execution request for service N is posterior to the reception of the service execution request for service M. For example, the reception of the service execution request for service 2 is posterior to the reception of the service execution request for service 1. Tasks A to E refer to the tasks executed by the processing elements PE.

### (Pattern 11)

In pattern 11, deallocation of computational resources is performed in the broadcast mode, and deallocation of processing paths is performed in the broadcast mode. Pattern 11 is a basic pattern, and deallocation of computational resources and deallocation of processing paths are normally performed in pattern 11. The process in pattern 11 is efficient, because all the deallocation processes can be performed at once.

### (Pattern 12)

In pattern 12, deallocation of computational resources is performed in the broadcast mode, and deallocation of processing paths is performed in the one-to-one mode. Normally, it is not needed to employ pattern 12. However, the pattern 12 is effectively employed in cases where the deallocations of processing paths are to be traced one by one to monitor only the status of the paths.

### (Pattern 13)

In pattern 13, deallocation of computational resources is performed in the one-to-one mode, and deallocation of processing paths is performed in the broadcast mode. A specific example is shown below.

Service 1: task A→C→D→B
Service 2: task A→B→C

In this case, only the computational resources for executing task D are unnecessary in service 2 as compared to service 1. However, the processing paths are totally different, and therefore all the processing paths are deallocated in the broadcast mode after execution of service 1. Thereafter, only the computational resource D is deallocated in the one-to-one mode, whereby all the computational resources to be used in service 2 can be left. There is another case in which pattern 13 is effectively employed. That is, pattern 13 is effectively employed in cases where only the deallocations of computational resources are to be traced one by one to monitor only the status of the computational resources.

### (Pattern 14)

In pattern 14, deallocation of computational resources is performed in the one-to-one mode, and deallocation of processing paths is performed in the one-to-one mode. A specific example is shown below.

Service 1: task A→B→C
Service 2: task A→B→D
Service 3: task E→B→D

In this case, service 2 uses a part of service 1 (i.e. task A and task B), and service 3 uses a part of service 2 (i.e. task B and task D). In this case, deallocation of the computational resources of task C in service 1 is performed in the one-to-one mode, and deallocation of the processing path between B and C is performed in the one-to-one mode. This also applies to task A in service 2 and the processing path between A and B. In this way, the computational resources and the processing paths can be partly rearranged. In addition, by employing the one-to-one mode, it can be traced until which computational resource the computational resource deallocation has progressed and until which processing path the deallocation has progressed. Therefore, the status of deallocation of the computational resources and the processing paths and the occurrence of errors can be monitored point by point.

### (Pattern 15)

In pattern 15, deallocation of computational resources is not performed, and deallocation of processing paths is performed in the broadcast mode. A specific example is shown below.

Service 1: task A→B→C→D
Service 2: task A→C→D→B

This combination pattern is effective in cases where service 2 uses all the processing elements PE used in service 1 without a change and the processing paths are totally deferent.

### (Pattern 16)

In pattern 16, deallocation of computational resources is not performed, and deallocation of processing paths is performed in the one-to-one mode. A specific example is shown below.

Service 1: task A→B→D
Service 2: task A→B→C→D

All the tasks that constitute service 1 are needed in service 2, and a part of the processing paths in service 1 can be used in service 2 without a change. In this case, in service 2, only deallocation of the processing path between B and D is performed in the one-to-one mode. Even in cases where a number of changes in the processing paths are to be made, this pattern is employed if the status of deallocation of the processing paths or errors are desired to be traced as described above.

### (Pattern 17)

In pattern 17, neither deallocation of computational resources nor deallocation of processing paths is performed. A specific example is shown below.

Service 1: task A→B→C
Service 2: task A→B→C→D

Specifically, in cases where all the computational resources and the processing paths in service 1 are needed in service 2, neither deallocation of computational resources nor deallocation of processing paths is performed.

In addition to the above described seven patterns, there may be the following two patterns. However, they cause a situation in which only paths are left allocated after deallocation of computational resources. Therefore, practically, there are no cases where the following patterns are employed.

| | computational resource | processing path |
|---|---|---|
| Pattern | deallocation | deallocation |
| 18 | broadcast | not performed |
| 19 | one-to-one | not performed |

According to the this embodiment, there can be provided a control unit that is capable of dynamically interchanging different functions according to requests, and capable of achieving alternative means if a function does not exist.

In the one-to-one mode, the processing element PE that can be repeatedly used as a computational resource can be kept allocated without being deallocated. Therefore, it is not necessary to reallocate the computational resource.

### Second Embodiment

Next, a distributed processing system including a control unit CU according to a second embodiment will be described. The basic configuration and the basic operation of the control unit CU according to the second embodiment are the same as those of the above-described first embodiment, and the portions same as those in the first embodiment will be denoted by the same reference signs to omit redundant description. The drawings referred to in the corresponding description in the first embodiment also apply to the second embodiment.

### (Dynamic Reconfigurable Processor)

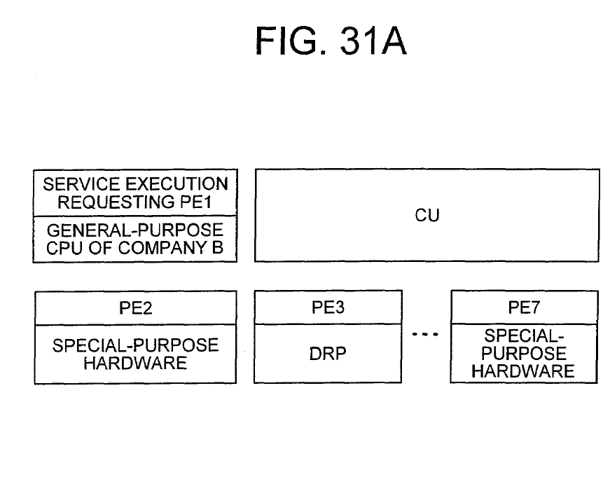

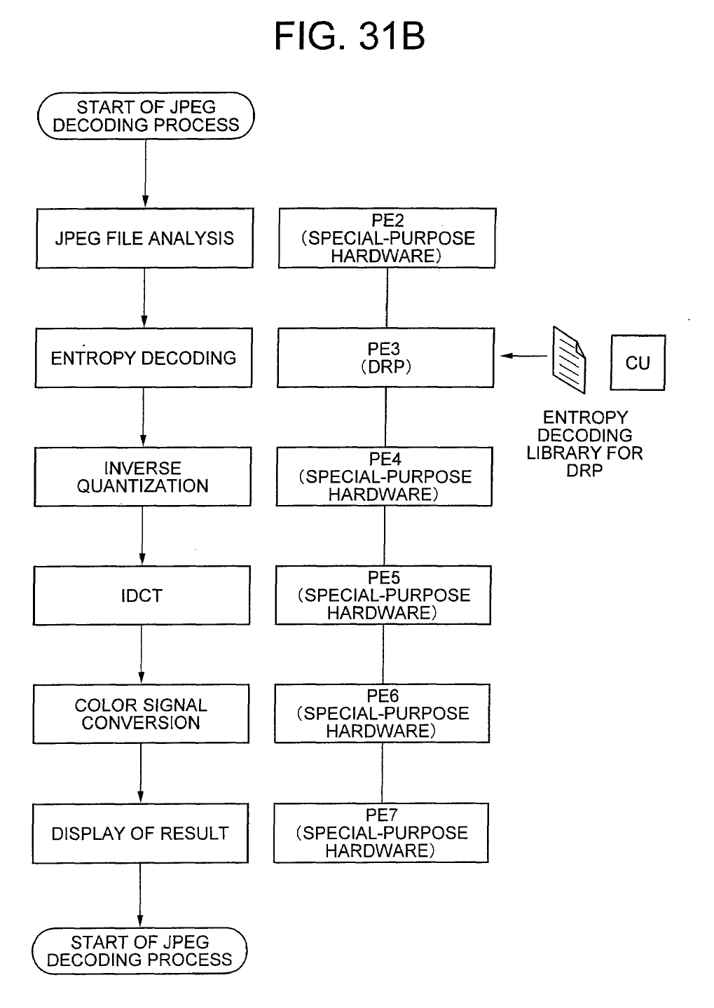

FIG. 31A shows a model of a distributed processing system including a control unit according to this embodiment. Seven processing elements PE1 to PE7 are connected to the control unit CU. The processing element PE1, which is a service execution requesting processing element, is a general-purpose CPU manufactured by Company B. The processing element PE3 is a dynamic reconfigurable processor (DRP). The other processing elements PE2 and PE4 to PE7 are special-purpose hardware. The processing elements PE2 and PE4 to PE7 can be realized by dedicated software that provides specific functions.

As described above, the dynamic reconfigurable processor is a processor in which hardware can be reconfigured on the real time basis into a configuration optimal for an application and is an IC in which both high processing speed and high flexibility can be achieved.

FIG. 31B shows a correspondence between a flow of a JPEG decoding process and the system configuration according to this embodiment. In this embodiment, the CU causes the processing element PE3 constituted of a dynamic reconfigurable processor to dynamically download reconfiguration information that provides the entropy decoding function from a library, and causes the dynamic reconfigurable processor to execute the entropy decoding task, to thereby implement a part of the JPEG decoding process.

The dynamic processing library associated with the dynamic reconfigurable processor includes, for example, information on interconnection in the dynamic reconfigurable processor, and the processing element PE3 constituted of the dynamic reconfigurable processor dynamically changes the wire connection with reference to the information in the library to provide the entropy decoding function. The other functions are executed by special-purpose hardware in the processing elements PE2 and PE4 to PE7.

### Flowchart of Embodiment 2

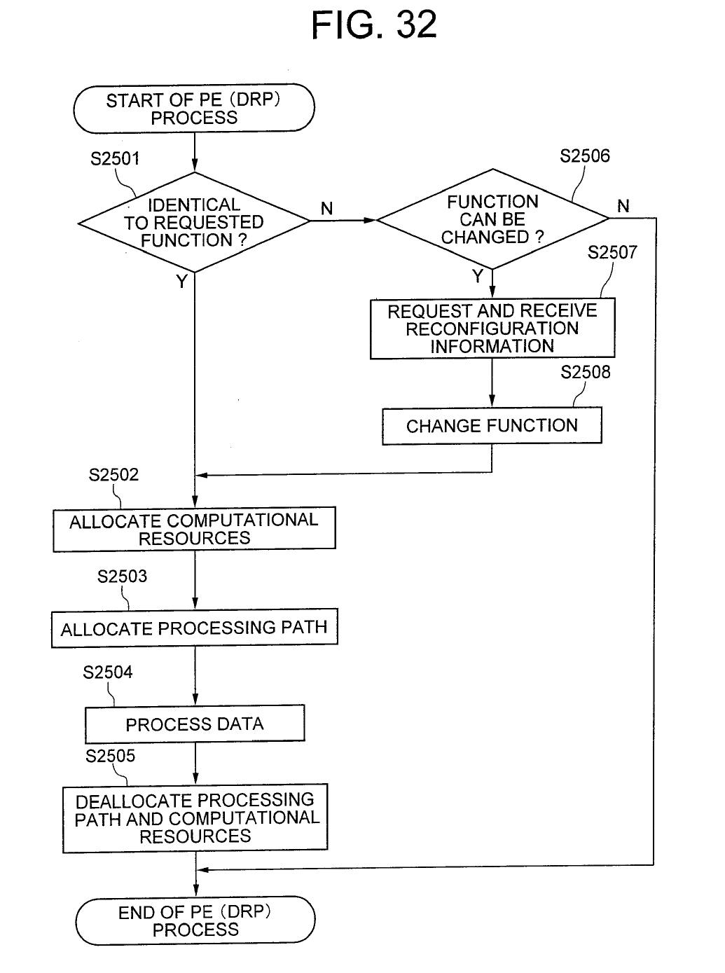

FIG. 32 is a flow chart of a basic control in the processing element PE3 constituted of a dynamic reconfigurable processor, among the processing elements according to this embodiment. This flow cart shows a basic flow. The detailed procedure will be described later.

The processing element PE3 receives a processing request. In step S2501, a determination is made as to whether its own function is identical to the requested function or not.

If the determination in step S2501 is affirmative, allocation of computational resources and allocation of processing path(s) are performed (step S2502 and step S2503), in a similar manner as the above-described first embodiment. Then, in step S2504, data processing is performed. In step S2505, the processing path(s) and the computational resources are deallocated. If the determination in step S2501 is negative, a determination is made as to whether its function can be changed or not, in step S2506.

If the determination in step S2506 is affirmative, reconfiguration information is requested and received in step S2507, if necessary. Then, in step S2508, the function of the processing element PE3 is changed. In step S2504, data processing is performed. If the determination in step S2506 is negative, the process is terminated.

### (Control Flow of PE (DRP))

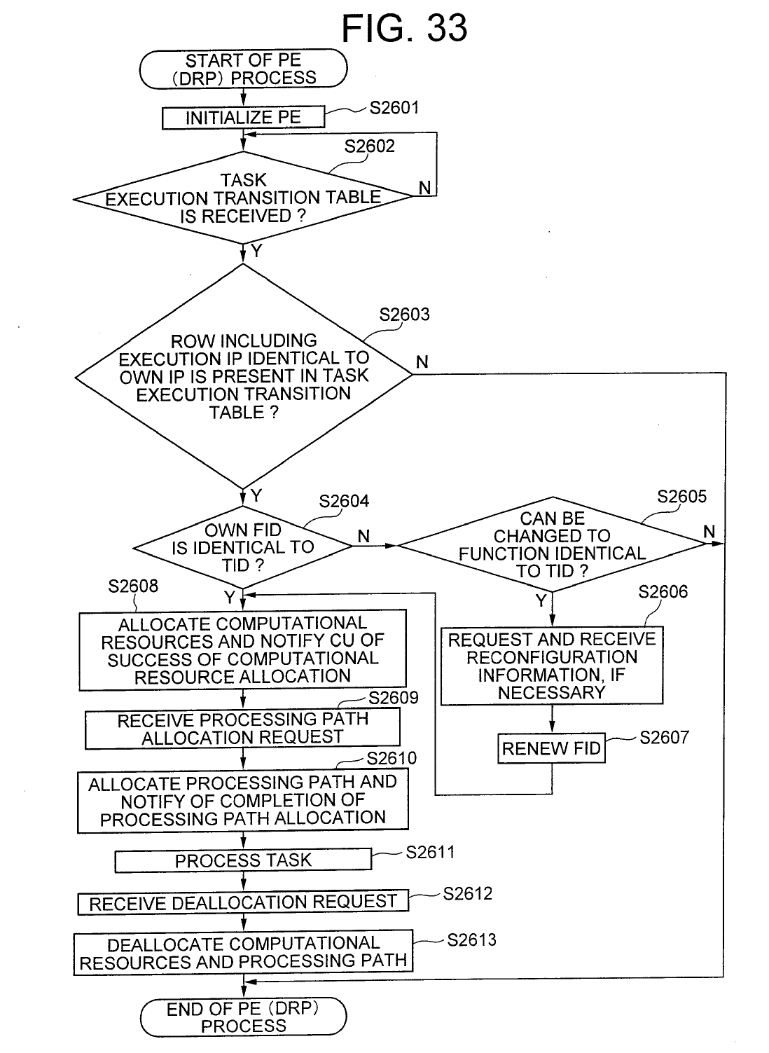

Next, the procedure of a control in the processing elements including a processing element PE3 constituted of a dynamic reconfigurable processor will be described with reference to FIG. 33.

In step S2601, the processing element PE is initialized. In step S2602, a determination is made as to whether the processing element PE has received a task execution transition table or not.

If the determination in step S2602 is affirmative, a determination is made, in step S2603, as to whether a row including an execution IP address identical to the IP address of the processing element PE itself is present or not (in the case of the entire task execution transition table is sent). If the determination in step S2602 is negative, the process of step S2602 is executed repeatedly. If the determination in step S2603 is affirmative, a determination is made, in step S2604, as to whether one of the FIDs of the processing element PE itself is identical to the TID or not. If the determination in step S2603 is negative, the process is terminated.

If the determination in step S2604 is affirmative, the processing element allocates computational resources, and notifies the control unit CU of success of computational resource allocation, in step S2608.

If the determination in step S2604 is negative, a determination is made as to whether the function of the processing element PE3 (dynamic reconfigurable processor) can be changed to the function corresponding to the TID or not, in step S2605.

If the determination in step S2605 is negative, the process is terminated. If the determination in step S2605 is affirmative, reconfiguration information is requested and received, in step S2606. In step S2607, the FID of the processing element PE3 is renewed. In step S2608, computational resources are allocated, and success of computational resource allocation is notified to the control unit CU.

In step S2609, the processing element PE receives a processing path allocation request. In step S2610, a processing path(s) is allocated, and completion of processing path allocation is notified to the control unit CU.

In step S2611, processing of the task is performed. In step S2612, a deallocation request is received from the control unit CU. In step S2613, the processing path(s) and the computational resources are deallocated.

In this way, in this embodiment, the control unit CU manages the dynamic processing library that includes reconfiguration information for implementing a specific(s) function of a special-purpose processing element(s) PE including special-purpose hardware and special-purpose software in the dynamic reconfigurable processor.

Here, “reconfiguration information” includes interconnection information of the dynamic reconfigurable processor and parameters for setting the content of processing. Then, the control unit CU sends reconfiguration information for the dynamic reconfigurable processor to the processing element PE with reference to the dynamic processing library. The processing element PE dynamically reconfigures the hardware of the dynamic reconfigurable processor based on the reconfiguration information in order to execute a specific function.

In the first embodiment, the general-purpose processing element PE adds the FID of the program to be newly introduced and loads the program into the memory. On the other hand, this embodiment is different from the first embodiment in that the dynamic reconfigurable processor dynamically reconfigures the hardware based on the reconfigurable information to execute a specific function.

### Third Embodiment

Next, a distributed processing system including a control unit according to a third embodiment of the present invention will be described. The basic configuration and the basic operation of the control unit CU according to the third embodiment are the same as those of the above-described first embodiment and the second embodiment, and the portions same as those in the first embodiment and the second embodiment will be denoted by the same reference signs to omit redundant description. The drawings referred to in the corresponding description in the first embodiment and the second embodiment also apply to the third embodiment.

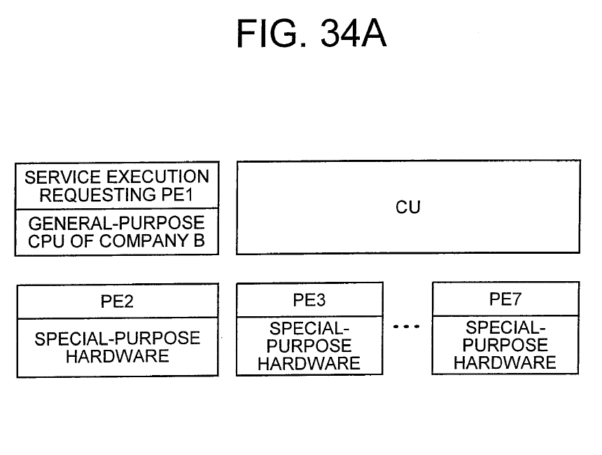

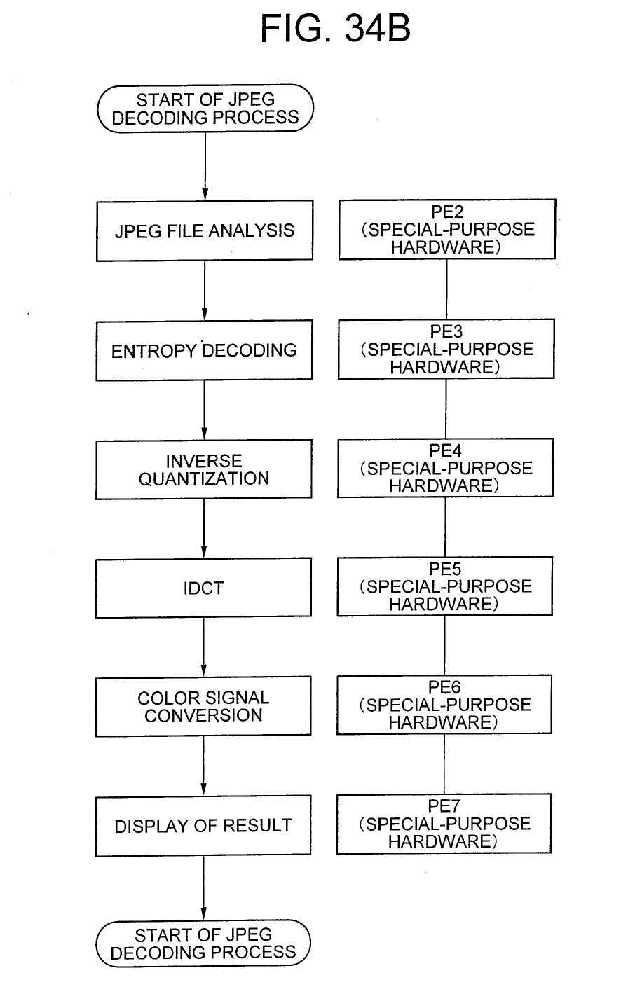

FIG. 34A shows a model of a distributed processing system including a control unit according to this embodiment. Seven processing elements PE1 to PE7 are connected to the control unit CU. The processing element PE1, which is a service execution requesting processing element, is a general-purpose CPU manufactured by Company B. The other processing elements PE2 to PE7 are constituted of special-purpose hardware. The special-purpose processing elements may be realized by software.

FIG. 34B shows a correspondence between a flow of a JPEG decoding process and the system configuration according to this embodiment. In this embodiment, since all of the six functions that constitute JPEG can be executed by special-purpose hardware in the processing elements PE2 to PE7, the CU need not download a dynamic processing library from the library.

A description of a basic control will be made taking as an example the processing element PE3 that is constituted of special-purpose hardware in this embodiment. Special-purpose software also performs the same control.

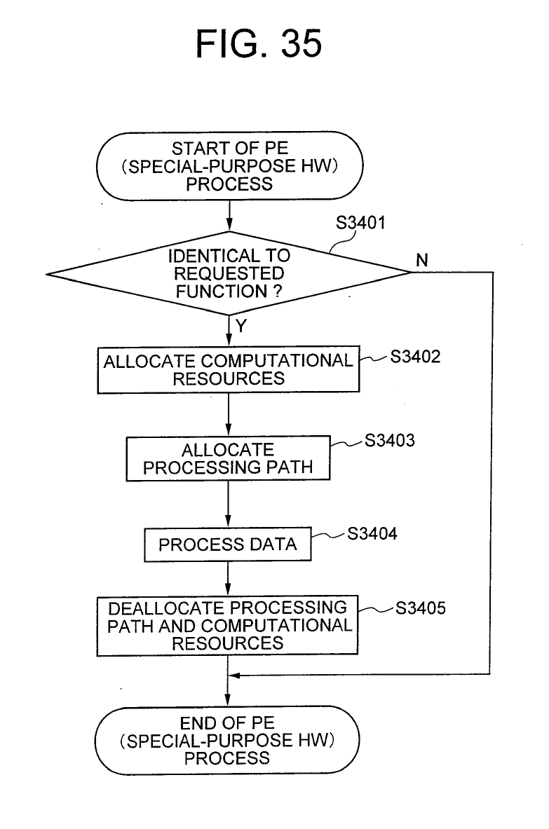

FIG. 35 is a flow chart of a basic control in the processing element PE3 constituted of special-purpose hardware.

The processing element PE3 receives a processing request. In step S3401, the processing element PE3 determines whether its own function is identical to the requested function or not.

If the determination in step S3401 is negative, the process is terminated. If the determination in step S3401 is affirmative, allocation of computational resources and allocation of processing path(s) are performed (step S3402 and step S3403), in a similar manner as the above-described first embodiment. In step S3404, data processing is performed. In step S3405, the processing path(s) and the computational resources are deallocated. Then, the process is terminated.

### (Control Flow of PE)

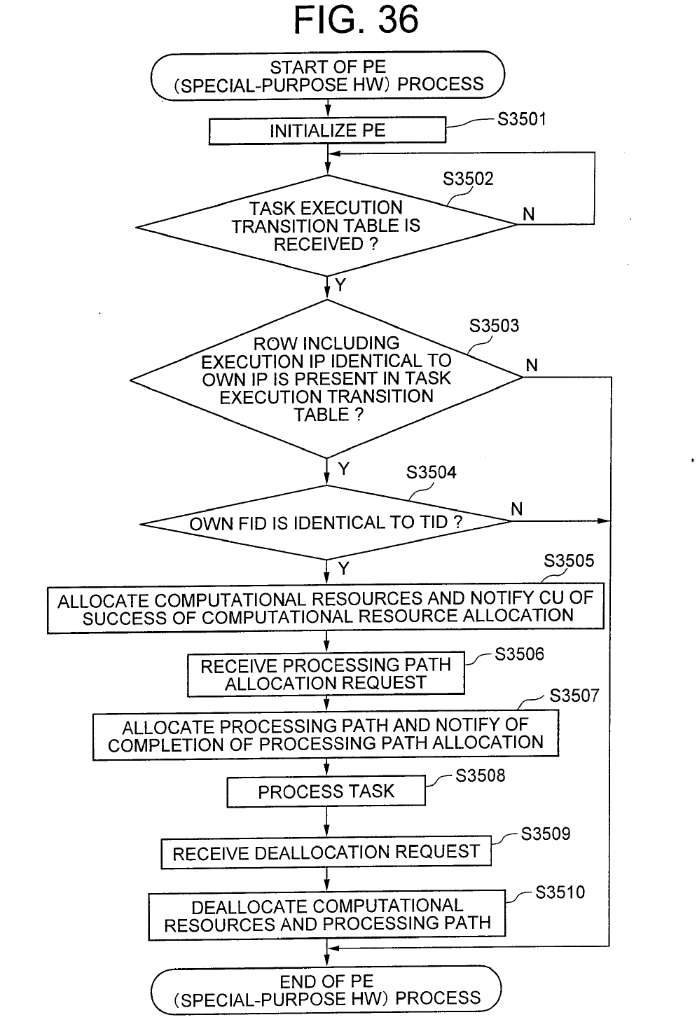

The procedure of a control in the processing element PE3 constituted of special-purpose hardware will be described with reference to FIG. 36.

In step S3501, the processing element PE is initialized. In step S3502, a determination is made as to whether the processing element PE has received a task execution transition table or not.

If the determination in step S3502 is affirmative, a determination is made as to whether the IP address of the processing element PE itself is identical to the execution IP address or not, in step S3503 (in the case where the entire task execution transition table has been sent). If the determination in step S3502 is negative, the process of step S3502 is executed repeatedly.

If the determination in step S3503 is affirmative, a determination is made, in step S3504, as to whether the FID of the processing element PE itself is identical to the TID or not. If the determination in step S3503 is negative, the processing element PE terminates the process.

If the determination in step S3504 is affirmative, computational resources are allocated, and success of computational resource allocation is notified to the control unit CU, in step S3505. In step S3506, a processing path allocation request is received. If the determination in step S3504 is negative, the processing element PE terminates the process.

In step S3507, a processing path(s) is allocated and completion of processing path allocation is notified to the control unit CU.

In step S3508, processing of the task is performed. In step S3509, a deallocation request is received. In step S3510, the processing path(s) and the computational resources are deallocated. Then, the processing element PE terminates the process.

Furthermore, in the third embodiment, all the processing elements PE may be constituted of special-purpose hardware.

The above described embodiments do not depend on the number of dynamic reconfigurable processors or the number of CPUs/virtual machines that included in the processing system. In other words, all the processing elements PE may be constituted of dynamic reconfigurable processors or all the processing elements PE may be constituted of CPUs/virtual machines in the first embodiment and the second embodiment.

In the above described embodiments, computational resources are verified using IP addresses. However, identifies are not limited to them, but verification may be done using other identifiers. Various modifications can be made without departing from the essence of the invention.

The library may also be obtained from. The server may be started either on the control unit CU or outside the CU. The control unit CU may cache library information.

As described above, the control unit according to the present invention is advantageous for a distributed processing system.

The possible application of the present invention is not limited to JPEG, but the present invention can also be applied to encoding using a still image codec or a motion picture codec including MPEG and H.264, and image processing including conversion, feature value extraction, recognition, detection, analysis, and restoration. In addition, the present invention can also be applied to multimedia processing including audio processing and language processing, scientific or technological computation such as a finite element method, and statistical processing.

The control unit according to the present invention is highly general versatility, and the present invention can advantageously provide a control unit that can uniformly manage all the software and hardware connected to a network, a distributed processing system including such a control unit, and a distributed processing method including such a control unit.

What is claimed is:

1. A control unit to which processing elements are connected, characterized in that the control unit comprises:
a determination section that determines information on a type and a function of the connected processing elements;
a library loading section that loads, as needed, program information or reconfiguration information for hardware included in a connected library into the processing elements; and
execution transition information control section that creates, based on information on an arbitrary service comprising a combination of one or more tasks to be executed by the processing elements and information on the type and the function of the processing elements determined by the determination section, execution transition information specifying a combination of the processing elements corresponding to the information on service and transmits it to the processing elements.

2. The control unit according to claim 1, characterized in that,
the processing elements include at least one of a special-purpose processing element that executes the specific function, a general-purpose processing element having the function that is changed by the program input thereto, and a dynamic reconfigurable processor having hardware that is reconfigured by the reconfiguration information input thereto, and
when the determination section determines that a processing element is the general purpose processing element or the dynamic reconfigurable processor, the execution transition information control section creates the execution transition information taking into account the program information or the reconfiguration information associated therewith.

3. The control unit according to claim 2, characterized in that
the processing elements include the general-purpose processing element,
the library includes the program information for causing the general-purpose processing element to execute a specific function specified in the execution transition information,
if the general-purpose processing element does not have the program for executing the specific function specified in the execution transition information, the library loading section loads the program information into the general-purpose processing element with reference to the library, and
the program is dynamically delivered to the general-purpose processing element in order to cause the general-purpose processing element to execute the specific function.

4. The control unit according to claim 3, characterized in that the library loading section dynamically delivers the program to the general-purpose processing element by a request from the general-purpose processing element.

5. The control unit according to claim 3, characterized in that the control unit obtains the program from a server.

6. The control unit according to claim 3, characterized in that the general-purpose processing element has a virtual processing section to implement the specific function among a plurality of functions.

7. The control unit according to claim 6, characterized in that the library includes a program associated with the virtual processing section that the general-purpose processing element has.

8. The control unit according to claim 2, characterized in that
the processing elements includes the dynamic reconfigurable processor,
the library includes the reconfiguration information for implementing a specific function specified in the execution transition information in the dynamic reconfigurable processor,
if the dynamic reconfigurable processor does not have the reconfiguration information for executing the specific function specified in the execution transition information, the library loading section loads the reconfiguration information into the dynamic reconfigurable processor with reference to the library, and
hardware of the dynamic reconfigurable processor is dynamically reconfigured in order to cause the dynamic reconfigurable processor to execute the specific function.

9. The control unit according to claim 8, characterized in that the library loading section dynamically delivers the reconfiguration information to the dynamic reconfigurable processor by a request from the dynamic reconfigurable processor.

10. The control unit according to claim 8, characterized in that the control unit obtains the reconfiguration information from a server.

11. The control unit according to claim 1, characterized in that the execution transition control section creates the execution transition information based on the information on service requested by a client and transmits it to the processing elements or the client, and
the processing elements or the client determines whether the task pertinent thereto specified in the execution transition information received thereby is executable or not and transmits information on the determination on executability/non-executability to the execution transition information control section, whereby a processing path of the tasks specified in the execution transition information is determined.

12. The control unit according to claim 11, characterized in that the control unit transmits control information concerning a computational resource allocation request, a computational resource deallocation request, a processing path allocation request, and a processing path deallocation request for executing the tasks specified in the execution transition information to the processing elements or the client associated with the tasks.

13. The control unit according to claim 12, characterized in that the control unit transmits same the execution transition information or the control information to the processing elements specified in the execution transition information and the client all at once.

14. The control unit according to claim 12, characterized in that the execution transition information or the control information is transmitted to the processing elements specified in the execution transition information and the client one by one.

15. The control unit according to claim 11, characterized in that the execution transition information control section extracts the execution transition information pertinent to each of the processing elements needed to execute specific tasks, from the transition execution information, and transmits the execution transition information thus extracted to each of the processing elements.

16. A distributed processing system including processing elements and a control unit to which the processing elements are connected, characterized in that the control unit comprises:
a determination section that determines information on a type and a function of the connected processing elements;
a library loading section that loads, as needed, program information or reconfiguration information for hardware included in a connected library into the processing elements; and
execution transition information control section that creates, based on information on an arbitrary service comprising a combination of one or more tasks to be executed by the processing elements and information on the type and the function of the processing elements determined by the determination section, execution transition information specifying a combination of the processing elements corresponding to the information on service and transmits it to the processing elements.

17. The distributed processing system according to claim 16, characterized in that:
the processing elements include at least one of a special-purpose processing element that executes the function, a general-purpose processing element having the function that can be changed by the program input thereto, and a dynamic reconfigurable processor having hardware that is reconfigured by the reconfiguration information input thereto, and
when the determination section determines that a processing element is the general purpose processing element or the dynamic reconfigurable processor, the execution transition information control section creates the execution transition information taking into account the program information or the reconfiguration information associated therewith.

18. A distributed processing system according to claim 16, characterized by further comprising a client that sends a service execution request to the control unit.

19. A distributed processing method characterized by comprising:
a determination step of determining information on a type and a function of the processing elements connected to a control unit;
a library loading step of loading, as needed, program information or reconfiguration information for hardware included in a connected library into the processing elements;
execution transition information control step of creating, based on information on an arbitrary service comprising a combination of one or more tasks to be executed by the processing elements and information on the type and the function of the processing elements determined by the determination section, execution transition information specifying a combination of the processing elements corresponding to the information on service and transmitting it to the processing elements; and
processing path determination step in which the processing elements or the client determines whether the task pertinent thereto specified in the execution transition information received thereby is executable or not, whereby a processing path of the tasks specified in the execution transition information is determined.
